(19) United States
(12) Patent Application Publication
(10) Pub. No.: US 2026/0086373 A1
(43) Pub. Date: Mar. 26, 2026

(54) METHOD AND SYSTEM FOR AUGMENTED REALITY DISPLAY WITH GEOMETRIC-PHASE LENSES

(71) Applicant: Magic Leap, Inc., Plantation, FL (US)

(72) Inventors: Erik Heath Arend, Boulder, CO (US); Vikramjit Singh, Pflugerville, TX (US); Hui-Chuan Cheng, Cooper City, FL (US); Lingshan Li, San Jose, CA (US)

(73) Assignee: Magic Leap, Inc., Plantation, FL (US)

(21) Appl. No.: 19/407,380

(22) Filed: Dec. 3, 2025

Related U.S. Application Data
(63) Continuation of application No. PCT/US2023/024476, filed on Jun. 5, 2023.

(51) Int. Cl. G02B 27/01; G02B 27/28

(52) U.S. Cl. CPC G02B 27/0172; G02B 27/283; G02B 2027/0178

(57) ABSTRACT

A method of operating an augmented reality display having a world side and a user side includes receiving world light incident on the augmented reality display from the world side, linearly polarizing the world light to produce first linearly polarized light characterized by a first polarization state, and rotating the first linearly polarized light to produce second linearly polarized light characterized by a second polarization state orthogonal to the first polarization state. The method also includes converting the second linearly polarized light to first circularly polarized light having a first handedness, converting the first circularly polarized light to second circularly polarized light having a second handedness, converting the second circularly polarized light to the second linearly polarized light; and blocking the second linearly polarized light.

### CROSS-REFERENCE TO RELATED APPLICATIONS

This application is a continuation and claims the benefit of and priority to International Patent Application No. PCT/US2023/024476, filed Jun. 5, 2023, entitled “METHOD AND SYSTEM FOR AUGMENTED REALITY DISPLAY WITH GEOMETRIC-PHASE LENSES,” the entire content of which is hereby incorporated by reference for all purposes.

### BACKGROUND OF THE INVENTION

Modern computing and display technologies have facilitated the development of systems for so called “virtual reality” or “augmented reality” experiences, wherein digitally reproduced images or portions thereof are presented to a viewer in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the viewer.

Despite the progress made in these display technologies, there is a need in the art for improved methods and systems related to augmented reality systems, particularly, display systems.

### SUMMARY OF THE INVENTION

The present invention relates generally to methods and systems related to projection display systems including wearable displays. More particularly, embodiments of the present invention provide methods and systems useful for eyepiece waveguide displays characterized by compact form factors and light weight. The invention is applicable to a variety of applications in computer vision and image display systems.

As described more fully herein, different configurations of an eyepiece waveguide stack (i.e., a see-through stack suitable for AR displays) with one or more groups of color-split geometric-phase lenses (CS-GPLs) are discussed. One configuration involves one group of CS-GPLs, a refractive lens, and a dynamic liquid crystal cell polarization state rotator. Another configuration incorporates two groups of CS-GPLs and a dynamic liquid crystal polarization rotator. The two configurations can not only achieve focusing/defocusing of virtual content, which can be referred to as the display-view, along with world view transmission, but also enable the world view dimming effect to be implemented as well as the blocking of the display-view transmission out of the eyepiece waveguide display to the world side.

Numerous benefits are achieved by way of the present invention over conventional techniques. For example, embodiments of the present invention provide methods and systems that are compact and light weight. Additionally, less chromatic aberration within the field of view (FOV) can be alleviated or potentially canceled. To be specific, the combination of the geometric phase lenses (GPLs) and a conventional lens as front lens and back lens, respectively, can lead to less chromatic aberration since the wavelength dispersion of the grating effect and the dispersion of the conventional lens are reversed. Because of the color-split setting of the GPLs, each of the CS-GPLs can be engineered specifically to best cancel the chromatic dispersion. In another scenario, when both lenses are GPLs stacks, the freedom to fine-tune the dispersion canceling effect is even more promising. Through the compensated phase design of the CS-GPLs as the back lens, it can launch the dispersion-free image from these two CS-GPLs. Another benefit of the setup is that the dynamic liquid crystal polarization rotator can simultaneously act as dimmer for the forward path and the privacy blocker for the backward path. Other benefits of some structures presented here are ghost image rejection. The use of a quarter-wave plate and a linear polarizer in certain configurations will block right hand circularly polarized light that enters the GPL. As discussed herein, a dimming feature is provided by embodiments of the present invention, but even without the dimmer present, the orthogonal circular polarizer will block light that is associated with leakage through the GPL. Furthermore, the use of a GPL can improve manufacturability, enable a unified structure, and provide chromatic corrections. These and other embodiments of the invention along with many of its advantages and features are described in more detail in conjunction with the text below and attached figures.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates a wearable device and a corresponding scene as viewed through a wearable device.

FIG. 2 illustrates an example wearable device incorporating a segmented dimmer in alignment with an eyepiece.

FIG. 3 illustrates an example wearable device with an eyepiece and a pixelated dimming element consisting of a spatial grid of dimming areas.

FIGS. 4A-4C illustrate examples of dimmer-specific dimming values that may be computed for different light source positions.

FIG. 5A is a simplified schematic diagram illustrating viewing of real content and virtual content produced using an eyepiece waveguide according to an embodiment of the present invention.

FIG. 5B is a simplified schematic diagram illustrating viewing of real content and virtual content produced using an eyepiece waveguide including a front geometric-phase lens according to an embodiment of the present invention.

FIG. 5C is a simplified schematic diagram illustrating viewing of real content and virtual content produced using an eyepiece waveguide including a rear geometric-phase lens according to an embodiment of the present invention.

FIG. 5D is a simplified schematic diagram illustrating viewing of real content and virtual content produced using an eyepiece waveguide including both a front geometric-phase lens and a rear geometric-phase lens according to an embodiment of the present invention.

FIG. 6 is a simplified schematic diagram illustrating an eyepiece waveguide display including a front geometric-phase lens according to an embodiment of the present invention.

FIG. 7A illustrates world light propagation through the eyepiece waveguide display illustrated in FIG. 6 with no active dimming according to an embodiment of the present invention.

FIG. 7B illustrates world light propagation through the eyepiece waveguide display illustrated in FIG. 6 with active dimming according to an embodiment of the present invention.

FIG. 7C is a simplified flowchart illustrating a method of performing dynamic dimming for an eyepiece waveguide display according to an embodiment of the present invention.

FIG. 8A illustrates virtual content propagation through the eyepiece waveguide display illustrated in FIG. 6 with no active dimming according to an embodiment of the present invention.

FIG. 8B illustrates virtual content propagation through the eyepiece waveguide display illustrated in FIG. 6 with active dimming according to an embodiment of the present invention.

FIG. 9A illustrates world light propagation through an eyepiece waveguide display including a rear geometric-phase lens with no active dimming according to an embodiment of the present invention.

FIG. 9B illustrates world light propagation through an eyepiece waveguide display including a rear geometric-phase lens with active dimming according to an embodiment of the present invention.

FIG. 9C is a simplified schematic diagram illustrating an eyepiece waveguide display including a rear geometric-phase lens according to a particular embodiment of the present invention.

FIG. 9D illustrates world light propagation through the eyepiece waveguide display illustrated in FIG. 9C according to an embodiment of the present invention.

FIG. 9E is a simplified schematic diagram illustrating an eyepiece waveguide display including a rear geometric-phase lens according to another particular embodiment of the present invention.

FIG. 9F illustrates world light propagation through the eyepiece waveguide display illustrated in FIG. 9E with no active dimming according to an embodiment of the present invention.

FIG. 9G illustrates world light propagation through the eyepiece waveguide display illustrated in FIG. 9E with active dimming according to an embodiment of the present invention.

FIG. 10 is a simplified schematic diagram illustrating an eyepiece waveguide display including both a front geometric-phase lens and a rear geometric-phase lens according to an embodiment of the present invention.

FIG. 11A illustrates world light propagation through the eyepiece waveguide display illustrated in FIG. 10 with no active dimming according to an embodiment of the present invention.

FIG. 11B illustrates world light propagation through the eyepiece waveguide display illustrated in FIG. 10 with active dimming according to an embodiment of the present invention.

FIG. 11C is a simplified flowchart illustrating a method of performing dynamic dimming for an eyepiece waveguide display according to an embodiment of the present invention.

FIGS. 12A-C illustrate liquid crystal orientation, wrapped geometric-phase, and total geometric-phase for a geometric-phase lenses in a first wavelength band.

FIGS. 12D-F illustrate liquid crystal orientation, wrapped geometric-phase, and total geometric-phase for a geometric-phase lenses in a second wavelength band.

FIGS. 12G-I illustrate liquid crystal orientation, wrapped geometric-phase, and total geometric-phase for a geometric-phase lenses in a third wavelength band.

FIG. 13 illustrates a schematic view of an example wearable system according to an embodiment of the present invention.

FIG. 14 illustrates an example computer system comprising various hardware elements according to an embodiment of the present invention.

### DETAILED DESCRIPTION OF SPECIFIC EMBODIMENTS

Wearable optical systems and devices, such as optical see through (OST) augmented reality (AR) devices, can be difficult to operate in extreme light conditions. For example, when a bright light source (e.g., the sun) is present, the light source can irritate the user's eyes and darker areas in the device's field of view become difficult for the user to see. Furthermore, when virtual content is being displayed at a wearable optical system, the virtual content that overlaps with the bright light source can be overpowered by the world light associated with the bright light source, while the virtual content displayed elsewhere in the device's field of view may be unobservable due to the potential irritation to the user's eyes due to the world light.

Embodiments of the present invention solve these and other problems by dimming the world light. In some embodiments, the dimming is performed globally, i.e., across the entire field of view of the device, whereas in other embodiments, the dimming is performed at different spatial locations within the device's field of view using left and right segmented dimmers. Thus, embodiments provide eye protection from high brightness light sources while retaining low opacity for areas with low light. In some embodiments implementing spatially segmented dimming, data captured by one or more cameras mounted on the wearable device is used to determine the amount of light each eye is exposed to and, based on that information, drive the segmented dimming. Embodiments may include a two camera configuration in which left and right cameras are positioned near (e.g., to the outside of) the dimmers, as well as a single camera configuration in which a camera is positioned between the dimmers or elsewhere along the wearable device.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

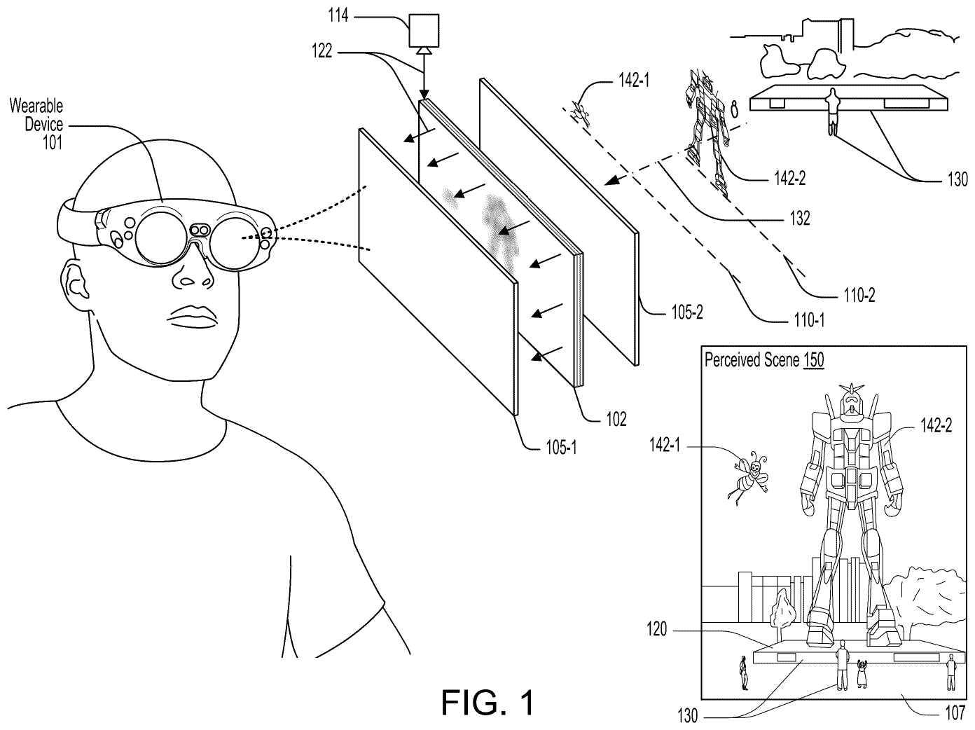

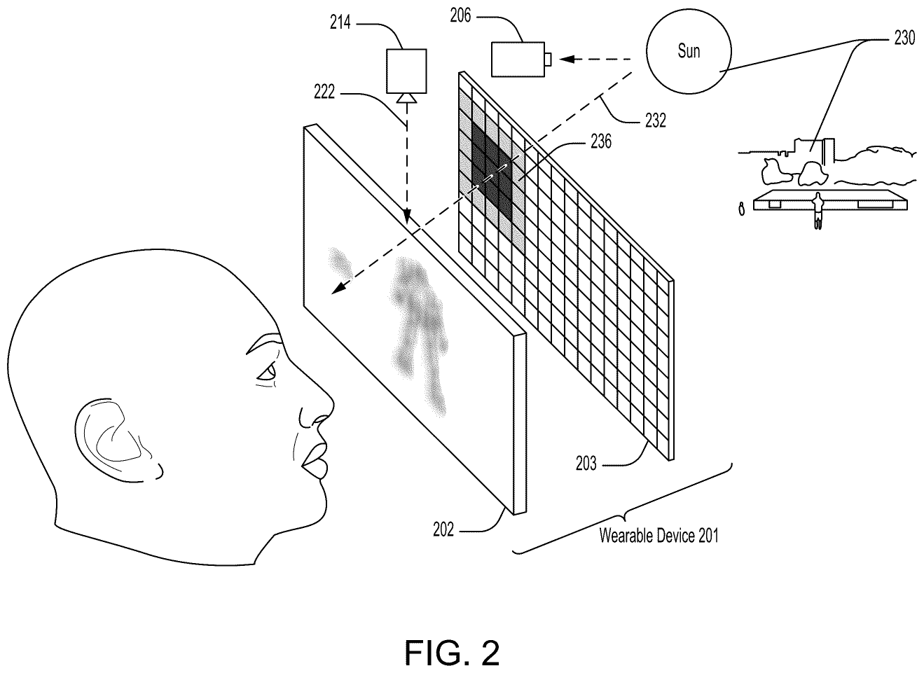

The figures herein follow a numbering convention in which the first digit or digits correspond to the figure number and the remaining digits identify an element or component in the figure. Similar elements or components between different figures may be identified by the use of similar digits. For example, 101 may reference element “101” in FIG. 1, and a similar element may be referenced as 201 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates a wearable device 101 and a corresponding scene 150 as viewed through wearable device 101, according to some embodiments of the present disclosure. Scene 150 is depicted wherein a user of an AR technology sees a real-world park-like setting 107 featuring various real-world objects 130 such as people, trees, buildings in the background, and a real-world concrete platform 120. In addition to these items, the user of the AR technology also perceives that they “see” various virtual objects 142 such as a robot statue 142-2 standing upon the real-world concrete platform 120, and a cartoon-like avatar character 142-1 flying by, which seems to be a personification of a bumble bee, even though these elements (character 142-1 and statue 142-2) do not exist in the real world. Due to the extreme complexity of the human visual perception and nervous system, it is challenging to produce a virtual reality (VR) or AR technology that facilitates a comfortable, natural-feeling, rich presentation of virtual image elements amongst other virtual or real-world imagery elements.

During operation, a projector 114 of wearable device 101 may project virtual image light 122 (i.e., light associated with virtual content) onto an eyepiece 102 of wearable device 101, which may cause a light field (i.e., an angular representation of virtual content) to be projected onto a retina of a user's eye in a manner such that the user perceives the corresponding virtual content as being positioned at some location within an environment of the user. For example, virtual image light 122 injected into eyepiece 102 and outcoupled by eyepiece 102 toward the user's eye may cause the user to perceive character 142-1 as being positioned at a first virtual depth plane 110-1 and statue 142-2 as being positioned at a second virtual depth plane 110-2. The user perceives the virtual content along with world light 132 corresponding to one or more world objects 130, such as platform 120.

In some embodiments, wearable device 101 may include various lens assemblies or other optical structures. In the illustrated example, wearable device 101 includes a first lens assembly 105-1 positioned on the user side of eyepiece 102 (the side of eyepiece 102 closest to the eye of the user) and a second lens assembly 105-2 positioned on the world side of eyepiece 102 (the side of eyepiece 102 furthest from the eye of the user). Each of lens assemblies 105-1, 105-2 may be configured to apply optical power to the light passing therethrough to converge and/or diverge light in a desired manner. While FIG. 1 shows a single projector 114 and single corresponding optical stack (including eyepiece 102 and lens assemblies 105), it is to be understood that wearable device 101 may include an optical stack for each eye with a single or multiple projectors configured to inject virtual image light into the respective optical stack(s).

FIG. 2 illustrates an example wearable device 201 incorporating a segmented dimmer 203 (or simply “dimmer”) in alignment with an eyepiece 202, according to some embodiments of the present disclosure. In some embodiments, segmented dimmer 203 may be transparent or semi-transparent when wearable device 201 is in an inactive mode or an off mode such that a user may view one or more world objects 230 when looking through eyepiece 202 and segmented dimmer 203. As illustrated, eyepiece 202 and dimmer 203 may be arranged in a side-by-side configuration and may form a device field of view that a user sees when looking through eyepiece 202 and dimmer 203. Although FIG. 2 illustrates a single eyepiece 202 and a single dimmer 203 (for illustrative reasons), it is to be understood that wearable device 201 may include two eyepieces and two dimmers, one for each eye of a user.

During operation, dimmer 203 may be adjusted to reduce an intensity of a world light 232 associated with world objects 230 impinging on dimmer 203, thereby producing a dimmed area 236 within the system field of view. Dimmed area 236 may be a portion or subset of the device field of view, and may be partially or completely dimmed. Dimmer 203 may be adjusted according to a plurality of spatially-resolved dimming values, which includes dimming values for dimmed area 236. Furthermore, during operation of wearable device 201, projector 214 may project a virtual image light 222 (i.e., light associated with virtual content) onto eyepiece 202 which may be observed by the user along with world light 232. As described in reference to FIG. 1, projecting virtual image light 222 onto eyepiece 202 may cause a light field to be projected onto the user's retina in a manner such that the user perceives the corresponding virtual content as being positioned at some location within the user's environment.

In some embodiments, wearable device 201 may include a camera 206 (alternatively referred to as a “light sensor”) configured to detect world light 232 and to produce a corresponding image (alternatively referred to as a “brightness image”). In one example, wearable device 201 may include left and right cameras (e.g., camera 206) positioned near left and right dimmers (e.g., dimmer 203), respectively. For each of the left and right sides, camera 206 may be positioned such that world light 232 detected by camera 206 is computationally relatable to the world light 232 that impinges on the respective (left or right) dimmer 203 and/or eyepiece 202. As described herein, the brightness images captured by the left and right cameras (alternatively referred to as “left brightness image” and “right brightness image”, respectively) may be combined and analyzed in such a way that left and right 2D brightness maps that directly correspond to the surfaces of the left and right dimmers and/or the perspectives of the user's left and right eyes, respectively, may be generated.

In the illustrated example, the dimming values for dimmer 203 are computed so as to align dimmed area 236 with world light 232 associated with the sun, thereby protecting the user's eyes and improving the AR experience. Specifically, camera 206 may detect world light 232 associated with the sun, which may be used to further determine a direction and/or a portion of the device field of view at which world light 232 associated with the sun passes through dimmer 203. In response, dimmer 203 may be adjusted to set dimmed area 236 to cover a portion of the device field of view corresponding to the detected world light. As illustrated, dimmer 203 may be adjusted so as to reduce the intensity of world light 232 at the center of dimmed area 236 at a greater amount than the extremities of dimmed area 236.

Although the embodiment illustrated in FIG. 2 is a segmented dimming implementation, other embodiments utilize a dimmer that reduced world light uniformly across the device's field of view. Thus, but segmented and global dimming applications are included within the scope of the present invention. For clarity, some embodiments described herein are discussed in terms of global dimming, but these embodiments can be modified to implement segmented dimming as appropriate to the particular application. One of ordinary skill in the art would recognize many variations, modifications, and alternatives.

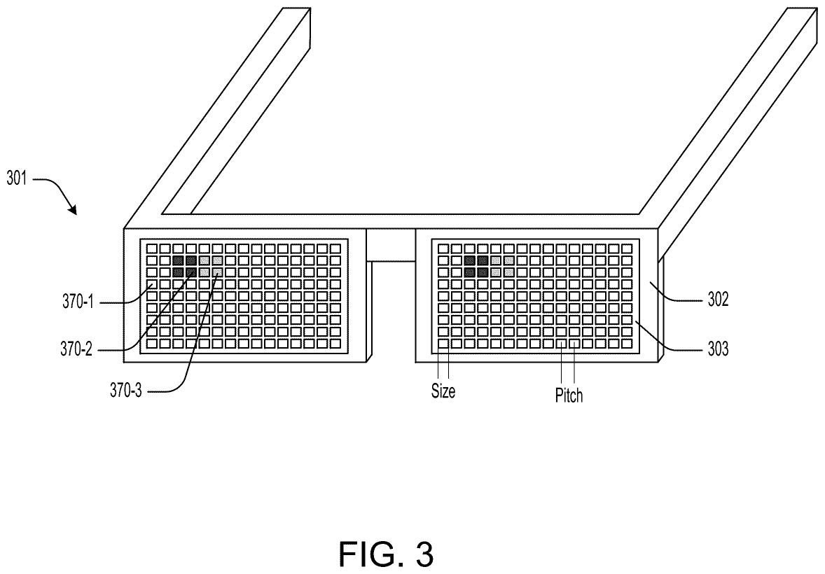

FIG. 3 illustrates an example wearable device 301 with an eyepiece 302 and a pixelated dimming element (i.e., dimmer 303) for each of the left and right sides of wearable device 301, according to some embodiments of the present disclosure. Each dimmer 303 may consist of a spatial grid of dimming areas (i.e., pixels 370) that can have various levels of dimming. Each of pixels 370 may have an associated size (i.e., width) and an associated spacing (i.e., pitch). It is to be understood that the quantity of pixels 370 in each dimmer 303 may be greater or less than the illustrated example (e.g., each dimmer 303 may include a 1028×1028 grid of pixels, a 500×1000 grid of pixels, etc.). As illustrated, the spatial grid of dimming elements may include one or more clear pixels 370-1 providing complete transmission of incident light, one or more fully dark pixels 370-2 providing complete dimming of incident light, and one or more intermediate dark pixels 370-3 providing partial dimming of incident light.

Adjacent pixels 370 within dimmer 303 may be bordering (e.g., when the pitch is equal to the size) or may be separated by gaps (e.g., when the pitch is greater than the size). In various embodiments, dimmer 303 may employ liquid crystal technology such as dye doped or guest host liquid crystals, twisted nematic (TN) or vertically aligned (VA) liquid crystals, or ferroelectric liquid crystals.

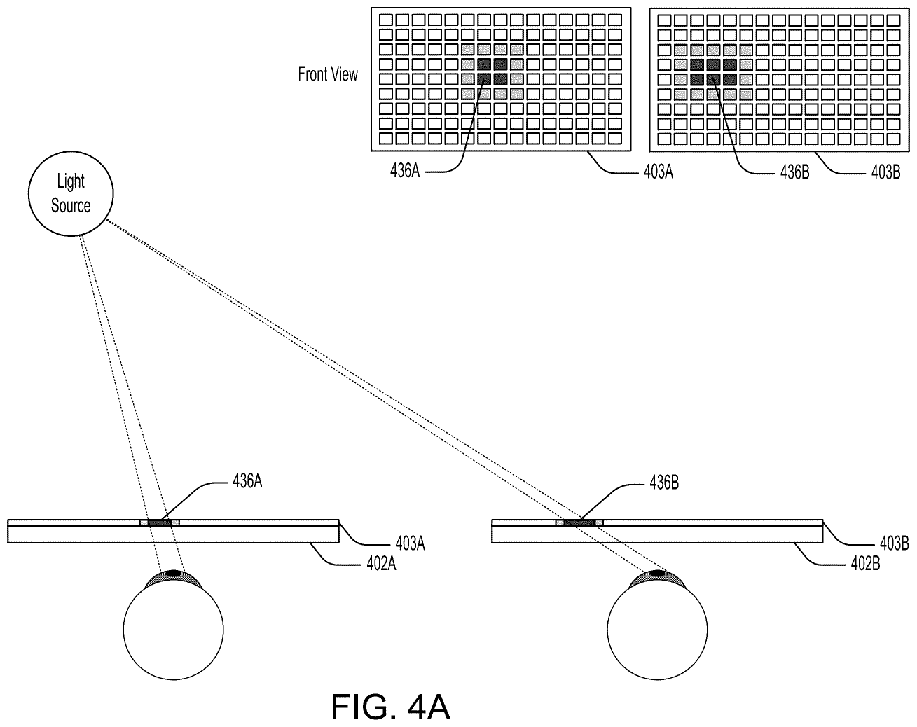

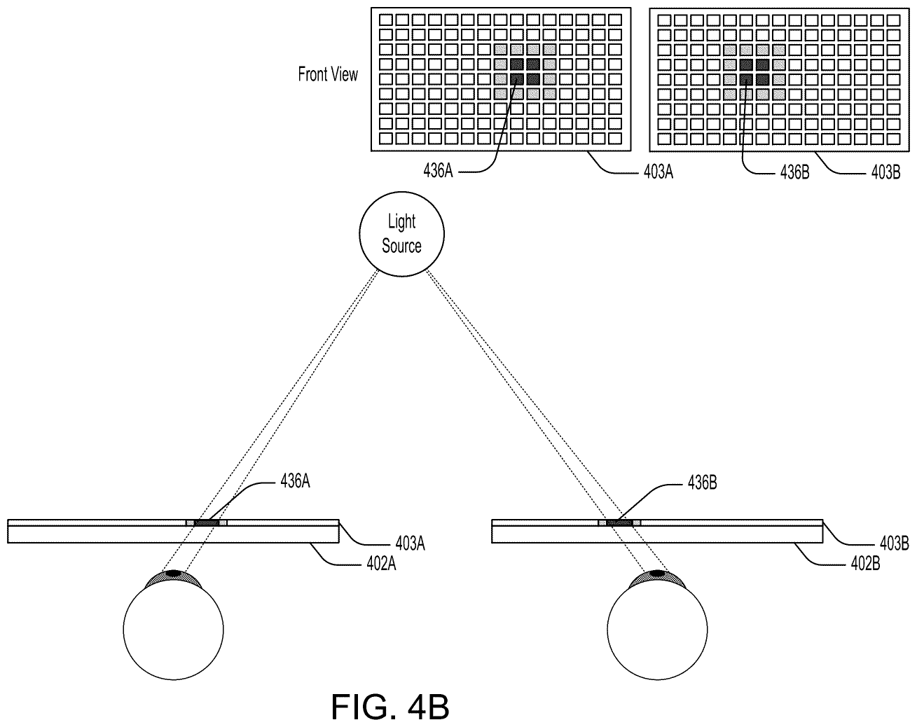

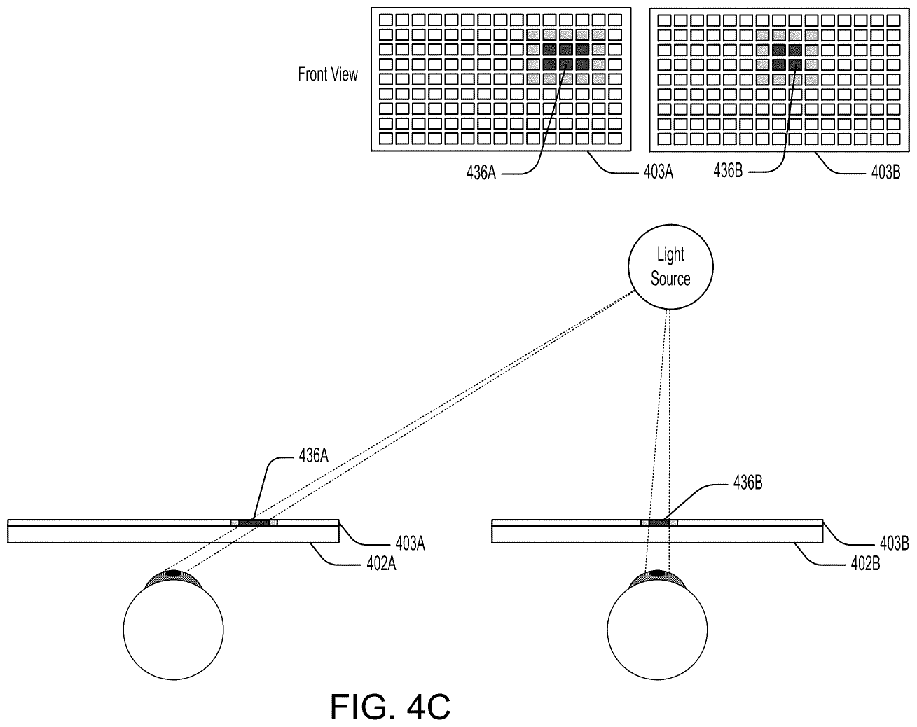

FIGS. 4A-4C illustrate examples of dimmer-specific dimming values that may be computed for different light source positions, according to some embodiments of the present disclosure. In the illustrated examples, the wearable device includes a left dimmer 403A in alignment with a left eyepiece 402A and a right dimmer 403B in alignment with a right eyepiece 403B. While the examples show dimmers 403 as being positioned on the world side of eyepieces 402, in some embodiments it may be desirable to position dimmers 403 on the user side of eyepieces 402 (on the side closest to the user's eyes).

In FIG. 4A, a set of left dimming values are computed for left dimmer 403A, forming dimmed area 436A, and a set of right dimming values are computed for right dimmer 403B, forming dimmed area 436B, so as to at least partially dim the world light emanating from the light source that is traveling toward the user's left and right eyes, respectively. It can be observed that the positions of dimmed areas 436 differ for dimmers 403 due to positions of the user's eyes relative to the light source. For example, the user's left eye is closer to the light source in the lateral direction than the user's right eye, and as such left dimmed area 436A is more centrally positioned within left dimmer 403A than right dimmed area 436B within right dimmer 403B.

In FIG. 4B, the light source has moved from the left of the user to directly in front of the user. Similar to that described for FIG. 4A, dimming values are computed for left dimmer 403A and right dimmer 403B so as to at least partially dim the world light emanating from the light source that is traveling toward the user's eyes. The positions of dimmed areas 436 again differ for dimmers 403 due to positions of the user's eyes relative to the light source. In FIG. 4C, the light source has moved from in front of the user to the right of the user. Dimming values are again computed for left dimmer 403A and right dimmer 403B so as to at least partially dim the world light emanating from the light source that is traveling toward the user's eyes, resulting in right dimmed area 436B being more centrally positioned within right dimmer 403B and left dimmed area 436A being positioned on the right side of left dimmer 403A.

The present invention relates generally to methods and systems related to projection display systems including wearable displays. More particularly, embodiments of the present invention provide methods and systems useful for eyepiece waveguide displays characterized by compact form factors and light weight. Embodiments of the present invention are applicable to a variety of applications in computer vision and image display systems and light field projection systems, including stereoscopic systems, systems that deliver beamlets of light to the retina of the user, or the like.

In some AR headset designs, the thickness of curved optics (e.g., refractive lenses) is a relatively high value in order to obtain the desired optical power. The use of these relatively thick lenses adds weight to the system and can limit the creative look of the product.

Geometric-phase, also referred to as the Pancharatnam-Berry phase, represents the phase acquired by light transmitting through an anisotropic material that has a local permittivity variation. Such permittivity variation can usually be generated by a nanostructure orientation of the anisotropic material. In optics applications, this geometric-phase can be understood as the polarization state of light moving adiabatically in a closed path on the Poincare sphere.

When such nanoscale birefringence is generated either by a periodic liquid crystal (LC) or liquid crystal polymer (LCP) arrangement, the geometric-phase element forms LC polarization gratings (PGs) (LCPGs). The working principle of LCPGs can be described as follows. The input polarization of the light determines the ratio of the 1^{st} and −1^{th} order of the grating efficiency, while the retardation of the LC or LCP determines the ratio between the transmittance (i.e., the 0^{th} order) and the total diffraction into the 1^{st} and the −1^{th} order. Thus, for a light wave entering a geometric-phase hologram (GPH), three output orders are produced (orders 1, 0, −1) with respective efficiencies (η₊₁, η₀, η₋₁) and undergo phase adjustment based on the geometric-phase imposed by the LCP local orientation.

This is because only the 1^{st} and −1^{th} order expansion of the Fourier Series exists in the permittivity matrix corresponding to such a geometric-phase periodic arrangement. When this permittivity matrix is used to calculate the electric and magnetic field using Maxwell Equations and Boundary Conditions, only three waves can exist: 1^{st}, and 0^{th}, and −1^{th} orders of transmission and reflection. With the high index of the LCP compared to air, geometric-phase lenses usually manifest minimal reflection, but the transmission of 1^{st}, 0^{th} and −1^{th} order is significant. The ratio among these three orders is determined by the retardation at different wavelength as:

$$η \pm ( {λ}_{H} ) = \frac{1 ∓ {S}_{3}}{2} {sin}^{2} \frac{Γ ( {λ}_{H} )}{2} \qquad ( 1 )$$

$${η}_{0} ( {λ}_{F} ) = {cos}^{2} \frac{Γ ( {λ}_{F} )}{2} , \qquad ( 2 )$$

where wavelength λ_{H} and λ_{F} meet the half-wave (HW) or full-wave (FW) retardation condition and S₃ is the Stoke's vector of circular polarization and F is the retardation of the film. When S₃ approaches 1 (or −1), the polarization of the light approaches perfect right-hand circular (or left-hand circular) polarization. For achromatic geometric-phase lenses, the HW retardation condition is equivalent to implement an achromatic half-wave plate (HWP) design, which enable green positioned in the middle of the HW retardation, while red and blue fall in the vicinity.

By bending such linear periodic arrangements into center symmetric arrangements and makes appropriate adjustment of the period in the radial direction, a geometric-phase lens (GPL) is formed. Therefore, such structures adopt both the grating phenomenon, and the lens geometry on the field on view (FOV), which can be described as follow:

$$Λ \cdot sin θ = λ \qquad ( 3 )$$

$$f \cdot tan θ = D / 2 , \qquad ( 4 )$$

where Λ, θ, λ, f, D are the period, incident angle, wavelength, focal length, and the lens diameter, respectively. From these equations, the focal length f can be determined as a function of both period and wavelength as follows:

$$f = r \cdot \sqrt{\frac{{Λ}^{2} - {λ}^{2}}{{λ}^{2}}} . \qquad ( 5 )$$

In practical AR applications, the lens system has two main functions: focusing the virtual content (display view) and transmitting world light (world view) with no focal power. In integrated eyepiece waveguide stacks, the light path experienced by world light and virtual content overlap after the virtual content is outcoupled from the eyepiece waveguide. Therefore, a two-lens system with compensating optical power can be utilized to fulfill the virtual content focusing and the world light transmission simultaneously. As for the focusing, refractive lenses provide high image quality and a large field of view (FOV). However, refractive lenses are also characterized by significant weight and complexity that can impact the compactness of the AR headset. A Fresnel lens can provide the advantages of less weight by cutting the phase into the fragmented structure. However, such fragmented structures also introduce some defects, resulting in trade-offs between the modulation transfer function (MTF) and the FOV. Besides, both the conventional refractive lens and the Fresnel lens suffer from chromatic aberration due to the dispersion of the material and such inherent physics phenomenon cannot be easily mitigated. Accordingly, embodiments of the present invention utilize the light weight and continuous phase profile provided by a GPL to achieve a flexible and compact solution for beam focusing and depth variations for virtual content and world light. Besides, the color split GPLs also provide a viable solution to alleviate the chromatic aberration, further improving the image quality.

Embodiments of the present invention utilize active dimming of the world light in certain scenarios, such as when a user wants to solely focus on the delicate structure represented by the virtual content. Additionally, embodiments of the present invention protect the user's privacy by blocking virtual content that would otherwise be outcoupled to the world side.

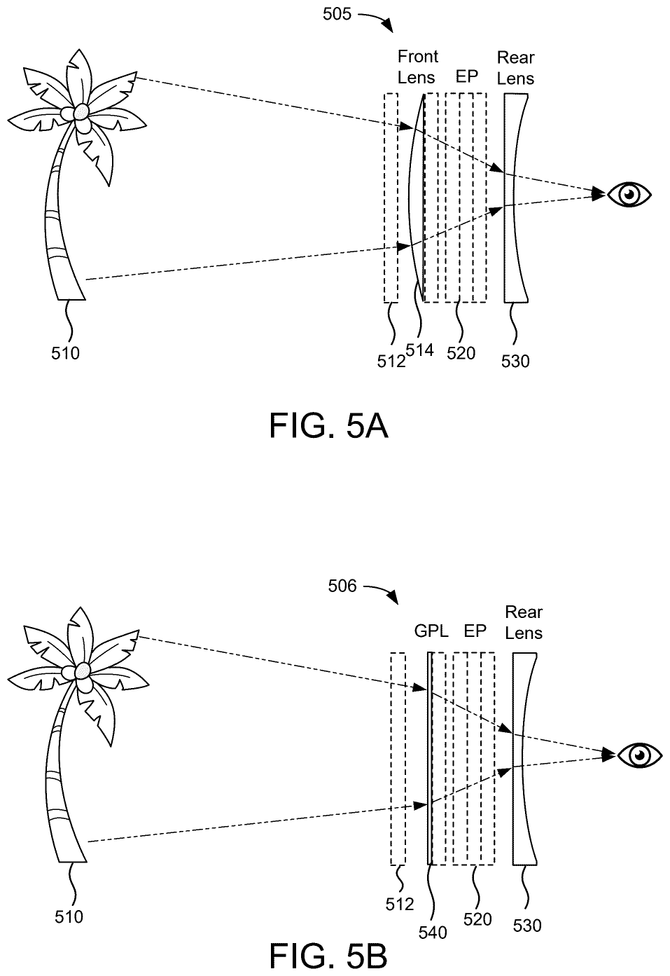

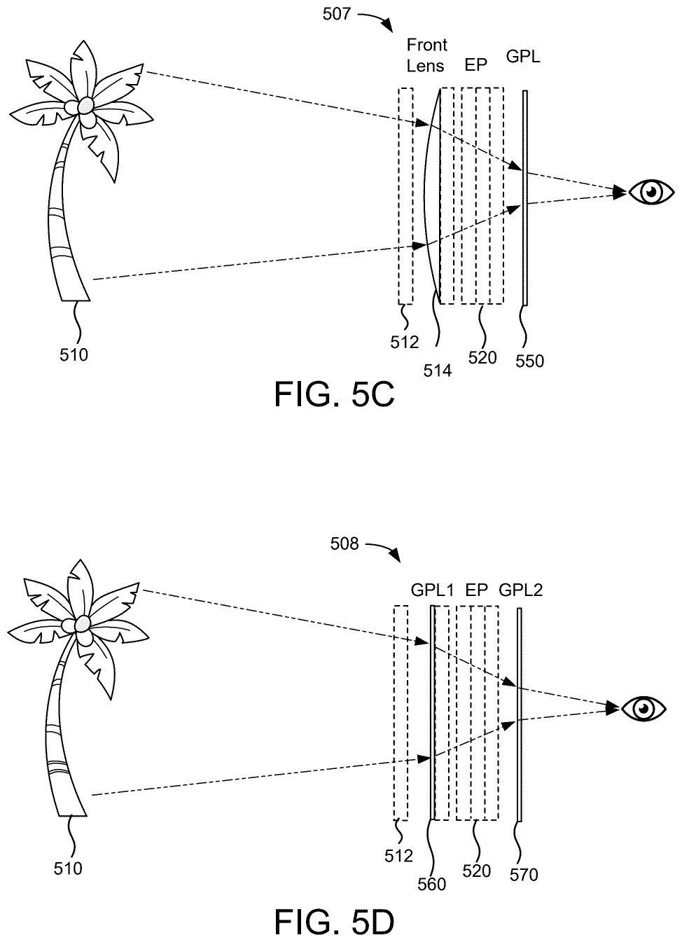

FIG. 5A is a simplified schematic diagram illustrating viewing of real content and virtual content produced using an eyepiece waveguide. As illustrated in FIG. 5A, an object 510 in the world is imaged by eyepiece waveguide display 505 along with virtual content produced using eyepiece waveguide 520 (EP). Optical elements 512 of eyepiece waveguide display 505 are illustrated to represent optical elements discussed herein, but not illustrated in FIG. 5A for purposes of clarity. World light is focused by front lens 514, passes through eyepiece waveguide 520, and is defocused by rear lens 530. In some embodiments, front lens 514 has a positive focal length f and rear lens 530 has a negative focal length −f. Focusing and defocusing can also be referred to as converging and diverging of light rays as appropriate to the particular application.

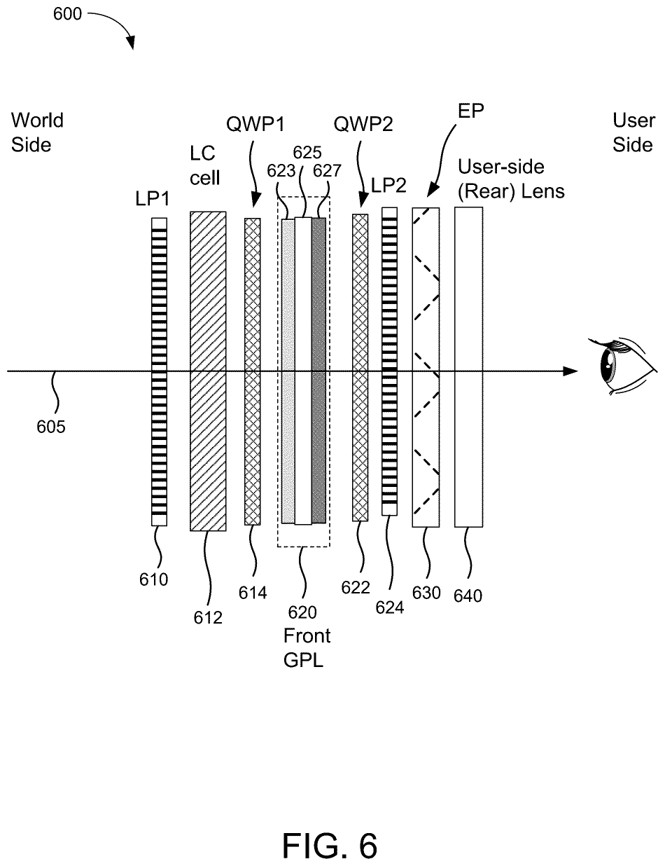

FIG. 5B is a simplified schematic diagram illustrating viewing of real content and virtual content produced using an eyepiece waveguide including a front geometric-phase lens according to an embodiment of the present invention. FIG. 5B shares common elements with FIG. 5A and the description provided in relation to FIG. 5A is applicable to FIG. 5B as appropriate. In FIG. 5B, eyepiece waveguide display 506 has been modified with respect to eyepiece waveguide display 505 illustrated in FIG. 5A, with front lens 514 being replaced by GPL 540. In addition, other optical elements can be added or removed to facilitate the functionality associated with GPL 540. Additional description related to eyepiece waveguide display 506 is provided in relation to the embodiment illustrated in FIG. 6.

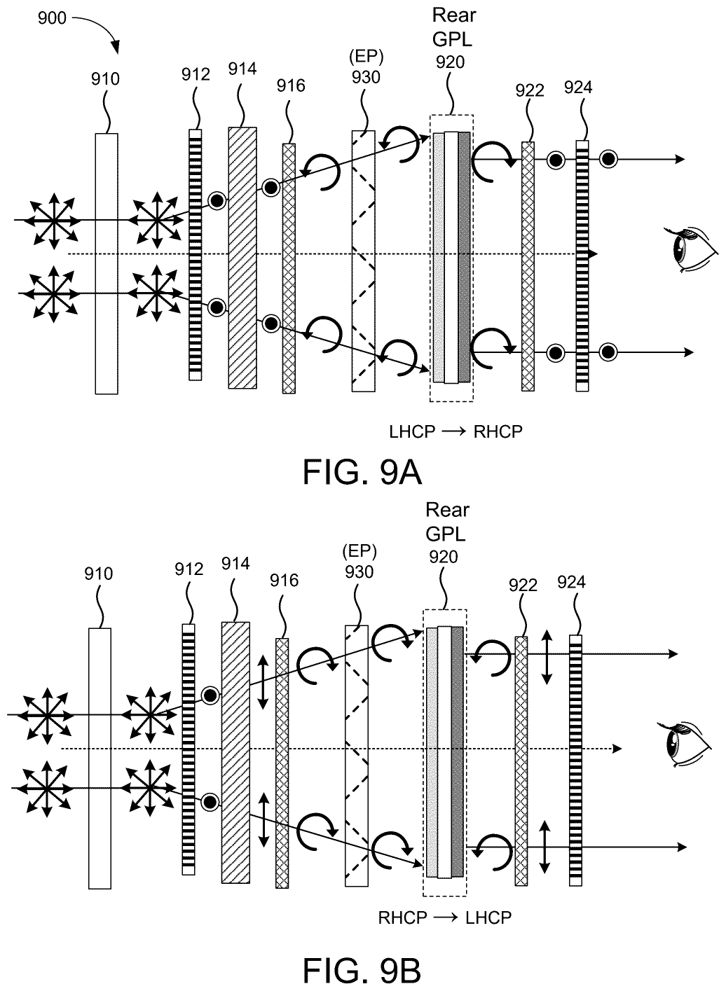

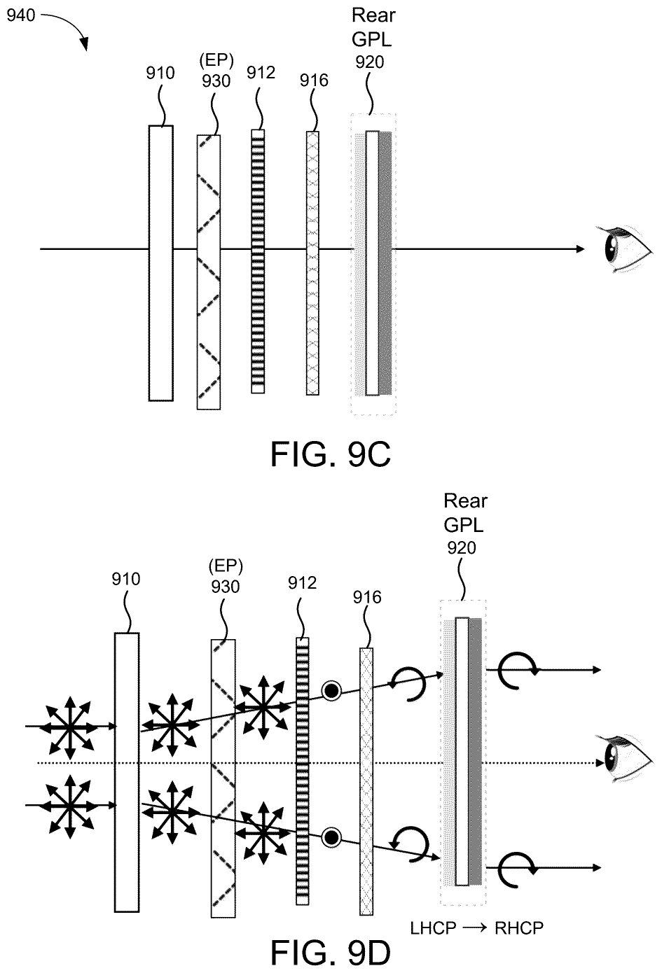

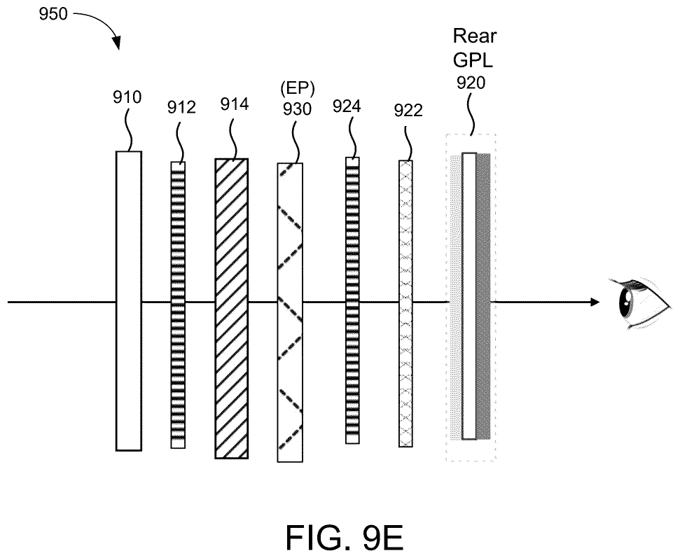

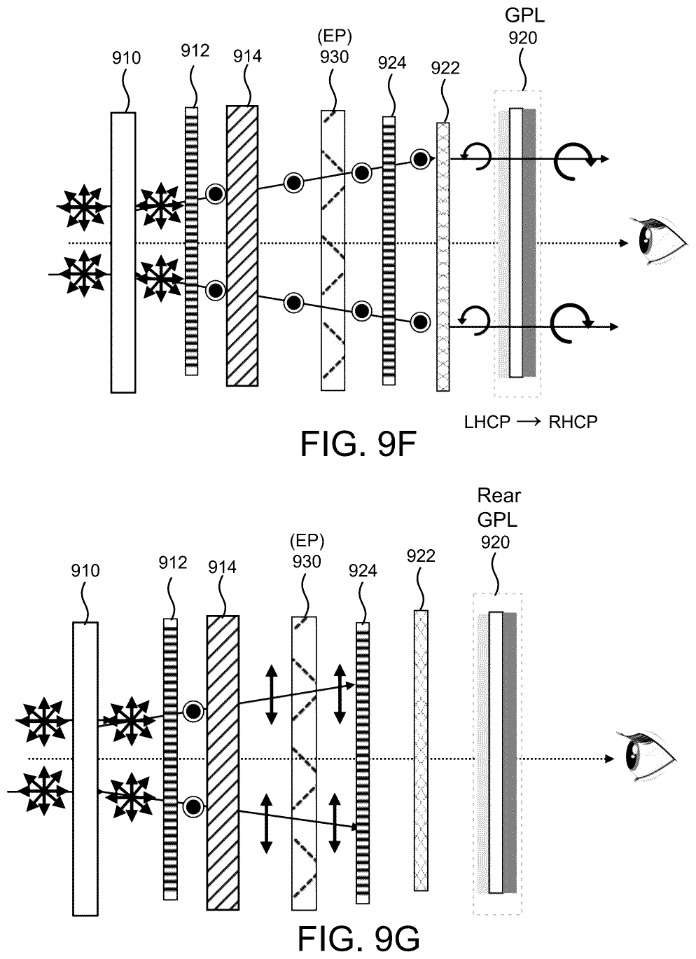

FIG. 5C is a simplified schematic diagram illustrating viewing of real content and virtual content produced using an eyepiece waveguide including a rear geometric-phase lens according to an embodiment of the present invention. FIG. 5C shares common elements with FIG. 5A and the description provided in relation to FIG. 5A is applicable to FIG. 5C as appropriate. In FIG. 5C, eyepiece waveguide display 507 has been modified with respect to eyepiece waveguide display 505 illustrated in FIG. 5A, with rear lens 530 being replaced by GPL 550. In addition, other optical elements can be added or removed to facilitate the functionality associated with GPL 550. Additional description related to eyepiece waveguide display 507 is provided in relation to the embodiment illustrated in FIGS. 9A and 9B. It will be noted that in the embodiment illustrated in FIG. 9A, the eyepiece waveguide is positioned on the user side of the rear GPL.

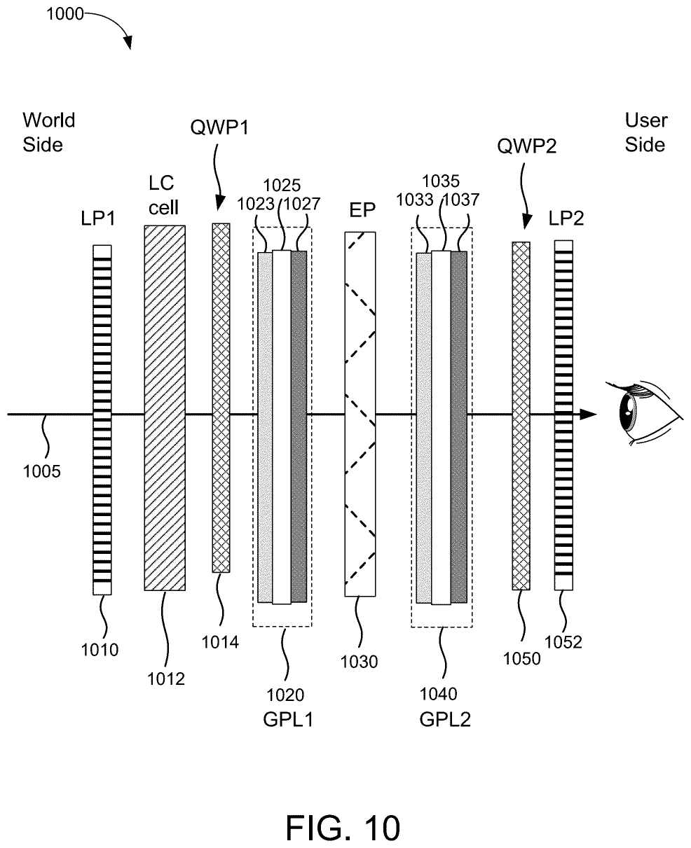

FIG. 5D is a simplified schematic diagram illustrating viewing of real content and virtual content produced using an eyepiece waveguide including both a front geometric-phase lens and a rear geometric-phase lens according to an embodiment of the present invention. FIG. 5D shares common elements with FIG. 5A and the description provided in relation to FIG. 5A is applicable to FIG. 5D as appropriate. In FIG. 5D, eyepiece waveguide display 508 has been modified with respect to eyepiece waveguide display 505 illustrated in FIG. 5A, with both front lens 514 and rear lens 530 being replaced by first GPL 560 and second GPL 570, respectively. In addition, other optical elements can be added or removed to facilitate the functionality associated with first GPL 560 and second GPL 570. Additional description related to eyepiece waveguide display 508 is provided in relation to the embodiment illustrated in FIG. 10.

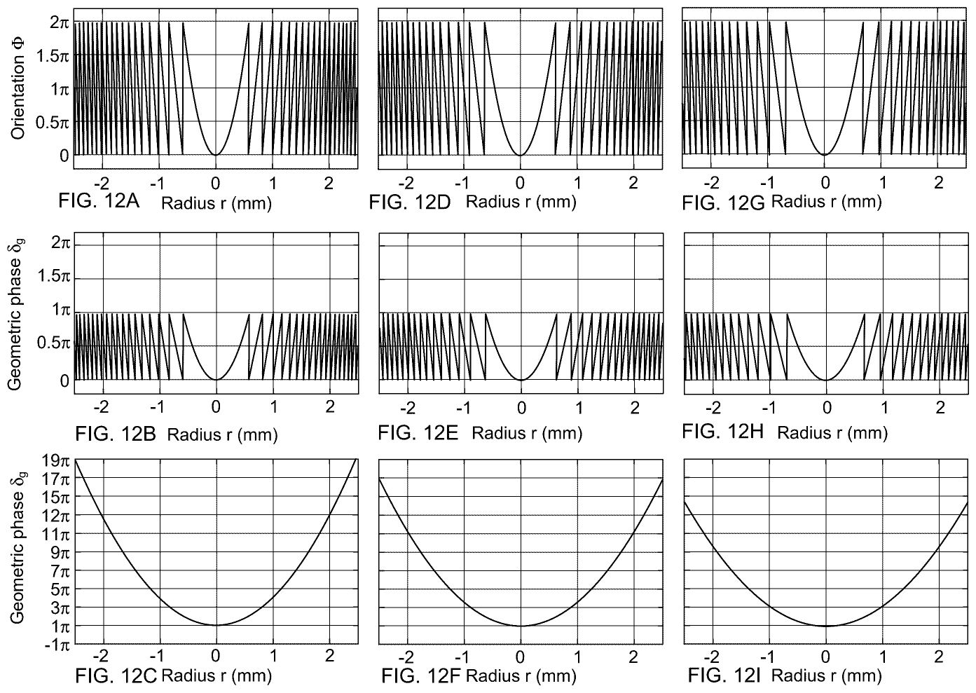

FIG. 6 is a simplified schematic diagram illustrating an eyepiece waveguide display including a front geometric-phase lens according to an embodiment of the present invention. As illustrated in FIG. 6, front GPL 620, also referred to as a world side GPL, is utilized to replace a world side refractive lens in the eyepiece waveguide display 600. Front GPL 620 includes three CS-GPLs, for example, first CS-GPL 623, which operates at blue wavelengths and has a total geometric-phase profile as shown in FIG. 12C, second CS-GPL 625, which operates at green wavelengths and has a total geometric-phase profile as shown in FIG. 12F, and third CS-GPL 627, which operates at red wavelengths and has a total geometric-phase profile as shown in FIG. 121. The rear lens 640, which can also be referred to as a user-side or back lens, is a refractive lens. Replacement of a front refractive lens with front GPL 620 enables the form factor of eyepiece waveguide display 600 to be reduced, providing a compact device as described more fully herein. Additionally, since front GPL 620 is planar, the thickness variation as a function of lens radius present in a refractive lens can be removed by the use of the planar front GPL 620, enabling distances between optical components in the eyepiece waveguide display to be reduced. Furthermore, since the GPL does not rely on an air/lens interface like a refractive lens, the GPL can be embedded in other optical elements, further reducing the form factor. Accordingly, although front GPL 620 is illustrated as a separate optical element in FIG. 6, this is not required by the present invention and the GPL can be integrated with other optical elements as appropriate to the particular application. One of ordinary skill in the art would recognize many variations, modifications, and alternatives.

Referring to FIG. 6, the eyepiece waveguide display 600 includes a number of optical elements disposed along optical axis 605 extending from the world side to the user side, which is represented by the user's eye. These optical elements include a first linear polarizer 610 (LP1), a liquid crystal cell 612, and a first quarter-wave plate 614 (QWP1). As described herein, first linear polarizer 610, liquid crystal cell 612, and first quarter-wave plate 614 form an optical dimmer structure. In some embodiments, second quarter-wave plate 622 and second linear polarizer 624 can be included as elements of the optical dimmer structure. Thus, in some embodiments, the world side optical structure includes second quarter-wave plate 622 and second linear polarizer 624, whereas in other embodiments, these elements can be included as components of the optical dimmer structure. In operation, incident light is linearly polarized by first linear polarizer 610 and the polarization state of the linearly polarized light can be rotated by liquid crystal cell 612. Depending on the polarization state (e.g., either the s-polarization state or the p-polarization state) produced using liquid crystal cell 612, first quarter-wave plate 614 will produce RHCP or LHCP light. Working in conjunction with second quarter-wave plate 622 and second linear polarizer 624 described below, world light can be dimmed using the optical dimmer structure.

The optical elements further include front GPL 620, a second quarter-wave plate 622 (QWP2), a second linear polarizer 624 (LP2), eyepiece waveguide 630 (EP), and rear lens 640, which is a refractive lens. The focal length of front GPL 620 and rear lens 640 are equal and opposite to each other, i.e., front GPL 620 has a focal length equal to f and rear lens 640 has a focal length equal to −f. As a result, world light will reach the user without being focused or defocused.

Different variations of eyepiece waveguide display 600 illustrated in FIG. 6 exist, including a first configuration: (1) The optic axis of first quarter-wave plate 614 and second quarter-wave plate 622 are aligned in the same direction, which has angle of ±45° with respect to the transmission axes of first linear polarizer 610 and second linear polarizer 624. In this configuration, first linear polarizer 610 and second linear polarizer 624 can have the same or orthogonal transmission directions. A second configuration can also be implemented: (2) The optic axis of first quarter-wave plate 614 and second quarter-wave plate 622 are orthogonal to each other, which has angle of ±45° respective to the transmission axes of first linear polarizer 610 and second linear polarizer 624. In this configuration, first linear polarizer 610 and second linear polarizer 624 can have the same or orthogonal transmission directions.

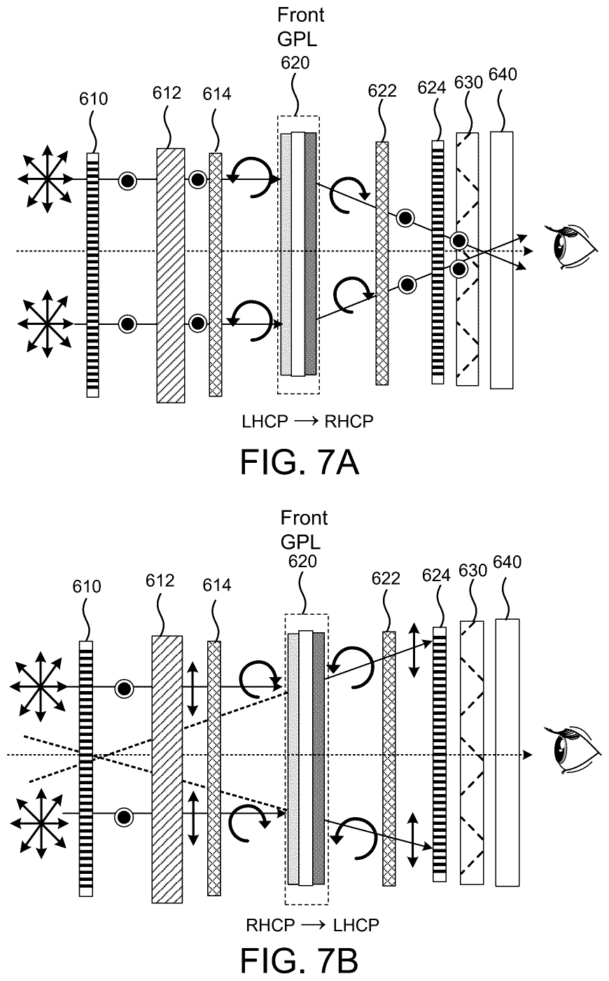

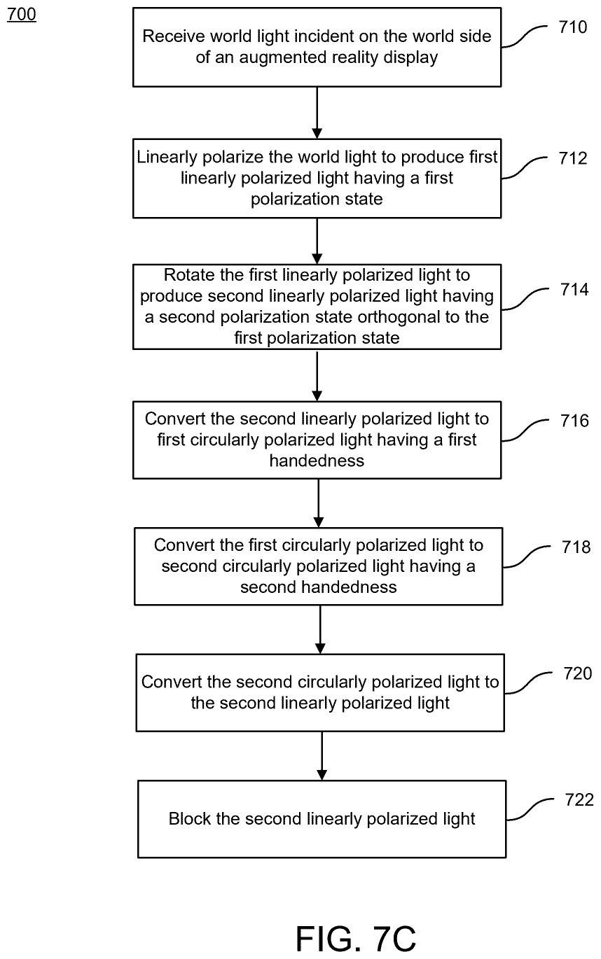

The use of a GPL as a replacement for a refractive lens is accompanied by the introduction of polarization control elements since front GPL 620 is polarization sensitive. In particular, operation of front GPL 620 can rely on light received at front GPL 620 being circularly polarized. This circularly polarized light is produced by a circular polarizer formed by first linear polarizer 610 and first quarter-wave plate 614. Accordingly, although size and weight reductions are enabled by the use of a GPL, the replacement of a refractive lens with a GPL is not suggested since this replacement involves the introduction of additional polarization control elements, which reduce the brightness of world light. However, as described more fully in relation to FIGS. 7A-7B, linear polarizers are already present in eyepiece waveguide display 600 in conjunction with the liquid crystal cell in order to provide a dimming function that improves the user experience. Since linear polarizers are already integrated into the eyepiece waveguide display 600, the use of polarization sensitive front GPL 620 does not rely on the introduction of additional polarization control elements, enabling the size and weight reductions to be maintained without additional brightness reduction.

Although in this embodiment, liquid crystal cell 612 is positioned between first linear polarizer 610 and first quarter-wave plate 614, this is not required and these optical elements, as well as other optical elements can be moved to different positions along the optical axis as appropriate to the particular application. For example, front GPL 620 can be positioned between second linear polarizer 624 and eyepiece waveguide 630. It should be noted that front GPL 620 can be positioned at locations along the optical axis where light having a circular polarization is present. As will be evident to one of skill in the art, relocation of the front GPL 620 from the position illustrated in FIG. 6 may entail the relocation of other optical elements, including the linear polarizer(s) or the quarter-wave plate(s). One of ordinary skill in the art would recognize many variations, modifications, and alternatives. Thus, the optical elements illustrated in FIG. 6 can be positioned at other locations as appropriate to the particular application and the order of the positioning of optical elements from world side to user side illustrated in FIG. 6 is not required. One of ordinary skill in the art would recognize many variations, modifications, and alternatives.

FIG. 7A illustrates world light propagation through the eyepiece waveguide display illustrated in FIG. 6 with no active dimming according to an embodiment of the present invention. As described below, in the OFF-state of the liquid crystal cell, no dimmer effect appears.

To illustrate the polarization evolution as light propagates through eyepiece waveguide display 600 illustrated in FIG. 6, one of the possible arrangements is utilized, an arrangement in which the optic axis of first quarter-wave plate 614, defined as φ_{c1} and the optic axis of second quarter-wave plate 622 φ_{c2} are set at φφ_{c1}=φ_{c2}=−45°, while the transmission axis of first linear polarizer 610 and second linear polarizer 624 are set at LP1=LP2=0°. In this embodiment, front GPL 620 is designed to receive light with a left-hand circular polarization (LHCP) as input in order to implement 1^{st} order diffraction and focusing (i.e., a positive focal length f) as depicted in FIG. 7C.

When liquid crystal cell 612 is in an OFF-state, the unpolarized world side light passes first linear polarizer 610, which produces linearly polarized light (illustrated as the s-polarization state), liquid crystal cell 612 operating in the OFF-state, which does not change the polarization state of the linearly polarized light, and first quarter-wave plate 614, which produces LHCP light. After focusing by front GPL 620, the output polarization after front GPL 620 is light with a right-hand circular polarization (RHCP). This RHCP light passes through second quarter-wave plate 622, which converts the light to linearly polarized light (illustrated as the s-polarization state). The linearly polarized light is aligned with the transmission axis of second linear polarizer 624, which enables the linearly polarized light to pass through the second linear polarizer 624, propagate through eyepiece waveguide 630, be defocused by rear lens 640, which has a negative focal length of −f, and reach the user. Thus, no dimming effect is observed with liquid crystal cell 612 in the OFF-state.

FIG. 7B illustrates world light propagation through the eyepiece waveguide display illustrated in FIG. 6 with active dimming according to an embodiment of the present invention. As described below, in the ON-state of the liquid crystal cell, a dimmer effect appears.

When liquid crystal cell 612 is in an ON-state, the unpolarized world side light passes first linear polarizer 610, which produces linearly polarized light (illustrated as the s-polarization state), liquid crystal cell 612 operating in the ON-state, which rotates the polarization state of the linearly polarized light by 90° (e.g., from the s-polarization state to the p-polarization state), and first quarter-wave plate 614, which produces RHCP light. After defocusing by front GPL 620, which is characterized by a negative focal length, the output polarization after front GPL 620 is LHCP light. This LHCP light passes through second quarter-wave plate 622, which converts the light to linearly polarized light (illustrated as the p-polarization state). The linearly polarized light is oriented 90° with respect to the transmission axis of second linear polarizer 624, which blocks the transmission of the linearly polarized light. As a result, the original world light does not reach eyepiece waveguide 630, rear lens 640, or the user. Accordingly, dimming is implemented with liquid crystal cell 612 operating in the ON-state. Dynamic dimming can be implemented by varying the voltage applied to liquid crystal cell 612, for example, reducing the voltage to enable 50% of the linearly polarized light to pass through second linear polarizer 624. If we denote m as the horizontal component of the amplitude that is transmitted through eyepiece waveguide display 600, then the portion of the intensity being blocked is I_{b}=1−m², with m≤1. In this manner, the dimming effect for world light can be realized.

FIG. 7C is a simplified flowchart illustrating a method of performing dynamic dimming for an eyepiece waveguide display according to an embodiment of the present invention. The method can be applied to the operation of an augmented reality display having a world side and a user side. The method 700 includes receiving world light incident on the augmented reality display from the world side (710) and linearly polarizing the world light to produce first linearly polarized light characterized by a first polarization state (712). The first polarization state can be an s-polarization state. The method also includes rotating the first linearly polarized light to produce second linearly polarized light characterized by a second polarization state orthogonal to the first polarization state (714), converting the second linearly polarized light to first circularly polarized light having a first handedness (716), and converting the first circularly polarized light to second circularly polarized light having a second handedness (718). The second polarization state can be a p-polarization state. The first handedness can be a right hand circular polarization and the second handedness can be a left hand circular polarization opposite to the right hand circular polarization.

The method further includes converting the second circularly polarized light to the second linearly polarized light (720) and blocking the second linearly polarized light (722). In some embodiments, concurrently with converting the first circularly polarized light to the second circularly polarized light, the method includes defocusing the second circularly polarized light. Blocking the second linearly polarized light can prevent the second linearly polarized light from reaching an eyepiece waveguide and a rear lens.

In some embodiments, the method also includes, prior to rotating the first linearly polarized light, converting the first linearly polarized light to the second circularly polarized light, initially converting the second circularly polarized light to the first circularly polarized light, converting the first circularly polarized light to the first linearly polarized light, and passing the first linearly polarized light through an eyepiece waveguide. Concurrently with initially converting the second circularly polarized light to the first circularly polarized light, the method can include focusing the first circularly polarized light. The method can further include generating virtual content using the eyepiece waveguide, directing the virtual content toward the user side, defocusing the virtual content, and defocusing the first linearly polarized light.

It should be appreciated that the specific steps illustrated in FIG. 7C provide a particular method of performing dynamic dimming for an eyepiece waveguide display according to an embodiment of the present invention. Other sequences of steps may also be performed according to alternative embodiments. For example, alternative embodiments of the present invention may perform the steps outlined above in a different order. Moreover, the individual steps illustrated in FIG. 7C may include multiple sub-steps that may be performed in various sequences as appropriate to the individual step. Furthermore, additional steps may be added or removed depending on the particular applications. One of ordinary skill in the art would recognize many variations, modifications, and alternatives.

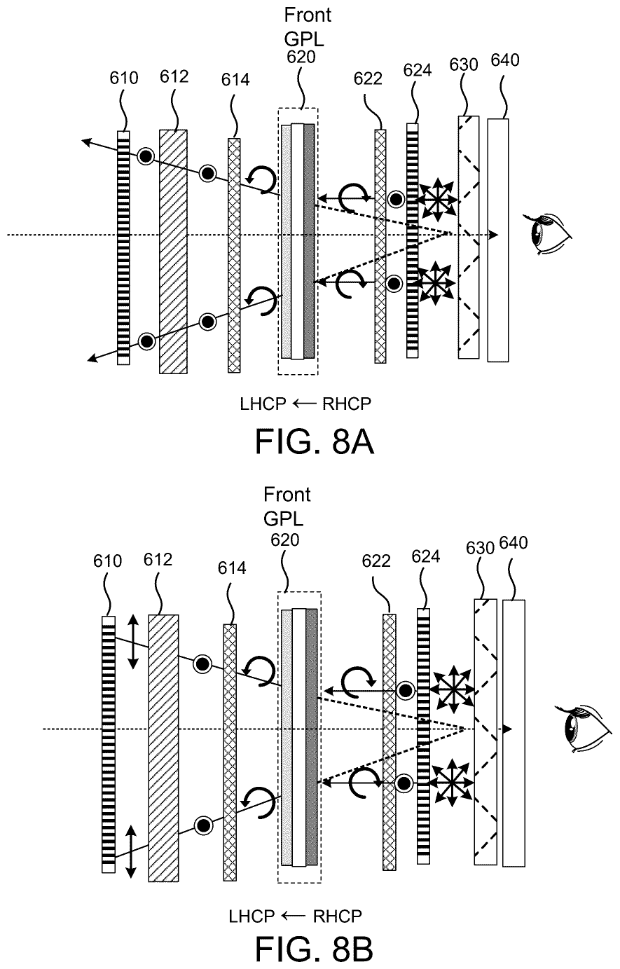

In relation to FIGS. 8A and 8B, an explanation is provided of a mechanism for protecting the user's privacy by blocking virtual content that could be outcoupled to the world side. The virtual content outcoupled from the eyepiece waveguide can have different polarization states due to the complexity of the eyepiece waveguide. Specifically, the polarization state of the virtual content can be influenced by different wavelengths, the number of bounces experienced in the waveguide, the number of times that the light rays interact with the gratings, the materials used for coating, and the like. Therefore, from the perspective of polarization design, such complicated polarization is equivalent to unpolarized light. Since the eyepiece waveguide is placed in front of the rear lens, this mechanism also applies to both single GPL and dual GPL configurations. Thus, only discussion in relation to eyepiece waveguide display 600 is provided herein since the same discussion will be applicable to eyepiece waveguide display 1000 illustrated in FIG. 10.

FIG. 8A illustrates virtual content propagation through the eyepiece waveguide display illustrated in FIG. 6 with no active dimming according to an embodiment of the present invention. In FIG. 8A, the minimum privacy condition is illustrated. The polarization evolution of virtual content, represented by unpolarized light is as follows. The unpolarized light outcoupled from eyepiece waveguide 630 propagates away from the user and passes second linear polarizer 624, which produces linearly polarized light (illustrated as the s-polarization state). Second quarter-wave plate 622 converts the linearly polarized light to RHCP light that is incident on front GPL 620, which produces LHCP light. This LHCP light passes through first quarter-wave plate 614, which converts the light to linearly polarized light (illustrated as the s-polarization state), which propagates through liquid crystal cell 612. The linearly polarized light is aligned with the transmission axis of first linear polarizer 610, which enables the linearly polarized light to pass through the first linear polarizer 610, and propagate toward the world side. Thus, the minimum privacy condition results with liquid crystal cell 612 in the OFF-state.

FIG. 8B illustrates virtual content propagation through the eyepiece waveguide display illustrated in FIG. 6 with active dimming according to an embodiment of the present invention. When the liquid crystal cell 612 is in the ON-state, the propagation of the virtual content from outcoupling through first quarter-wave plate 614 is the same as discussed in relation to FIG. 8A. However, when the liquid crystal cell 612 is ON, the linearly polarized light incident on the liquid crystal cell 612 (illustrated as the s-polarization state) is rotated by 90° (illustrated as the p-polarization state). This linearly polarized light produced by liquid crystal cell 612 is oriented 90° with respect to the transmission axis of first linear polarizer 610, which blocks the transmission of the linearly polarized light. As a result, the virtual content does not propagate into the world side.

It should be noted that the privacy function provided by embodiments of the present invention as illustrated in FIG. 8B is not independent from the dimming functionality discussed in relation to FIG. 7B. As discussed herein, the light emitted from the eyepiece toward the world and the world light propagating toward the user are both dimmed during operation as illustrated by the light emitted from the eyepiece being blocked as shown in FIG. 8B and the world light being dimmed as shown in FIG. 7B.

FIG. 9A illustrates world light propagation through an eyepiece waveguide display including a rear geometric-phase lens with no active dimming according to an embodiment of the present invention. The eyepiece waveguide display illustrated in FIG. 9A shares common features with the eyepiece waveguide display 600 illustrated in FIG. 6, but with a refractive front lens and the rear lens implemented as a GPL as illustrated in FIG. 5C. Thus, the discussion provided in relation to FIGS. 6-8B is applicable to FIGS. 9A and 9B as appropriate. As described below, in the OFF-state of the liquid crystal cell, no dimmer effect appears.

To illustrate the polarization evolution as light propagates through eyepiece waveguide display 900 illustrated in FIG. 9A, one of the possible arrangements is utilized, an arrangement in which the optic axis of first quarter-wave plate 916, defined as φ_{c1} and the optic axis of second quarter-wave plate 922 φ_{c2} are set at φ_{c1}=φ_{c2}=−45°, while the transmission axis of first linear polarizer 912 and second linear polarizer 924 are set at LP1=LP2=0°. In this embodiment, rear GPL 920 is designed to receive LHCP light as input in order to implement 1^{st} order diffraction and focusing (i.e., a positive focal length f) as depicted in FIG. 9A.

When liquid crystal cell 914 is in an OFF-state, the unpolarized world side light is defocused by front lens 910, which is implemented as a refractive lens in this embodiment, passes first linear polarizer 912, which produces linearly polarized light (illustrated as the s-polarization state), liquid crystal cell 914 operating in the OFF-state, which does not change the polarization state of the linearly polarized light, and first quarter-wave plate 916, which produces LHCP light. After propagating through eyepiece 930 and focusing by rear GPL 920, the output polarization after rear GPL 920 is RHCP light. This RHCP light passes through second quarter-wave plate 922, which converts the light to linearly polarized light (illustrated as the s-polarization state). The linearly polarized light is aligned with the transmission axis of second linear polarizer 924, which enables the linearly polarized light to pass through the second linear polarizer 924 and reach the user. Thus, no dimming effect is observed with liquid crystal cell 914 in the OFF-state.

FIG. 9B illustrates world light propagation through an eyepiece waveguide including a rear geometric-phase lens with active dimming according to an embodiment of the present invention. As described below, in the ON-state of the liquid crystal cell, a dimmer effect appears.

When liquid crystal cell 914 is in an ON-state, the unpolarized world side light is defocused by front lens 910, which is implemented as a refractive lens in this embodiment, passes first linear polarizer 912, which produces linearly polarized light (illustrated as the s-polarization state), liquid crystal cell 914 operating in the ON-state, which rotates the polarization state of the linearly polarized light by 90° (e.g., from the s-polarization state to the p-polarization state), and first quarter-wave plate 916, which produces RHCP light. After propagation through eyepiece 930 and focusing by rear GPL 920, which is characterized by a positive focal length, the output polarization after rear GPL 920 is LHCP light. This LHCP light passes through second quarter-wave plate 922, which converts the light to linearly polarized light (illustrated as the p-polarization state). The linearly polarized light is oriented 90° with respect to the transmission axis of second linear polarizer 924, which blocks the transmission of the linearly polarized light. As a result, the original world light does not reach the user. Accordingly, dimming is implemented with liquid crystal cell 914 operating in the ON-state. Dynamic dimming can be implemented by varying the voltage applied to liquid crystal cell 914, for example, reducing the voltage to enable 50% of the linearly polarized light to pass through second linear polarizer 924. If we denote m as the horizontal component of the amplitude that is transmitted through eyepiece waveguide display 900, then the portion of the intensity being blocked is I_{b}=1−m², with m≤1. In this manner, the dimming effect for world light can be realized.

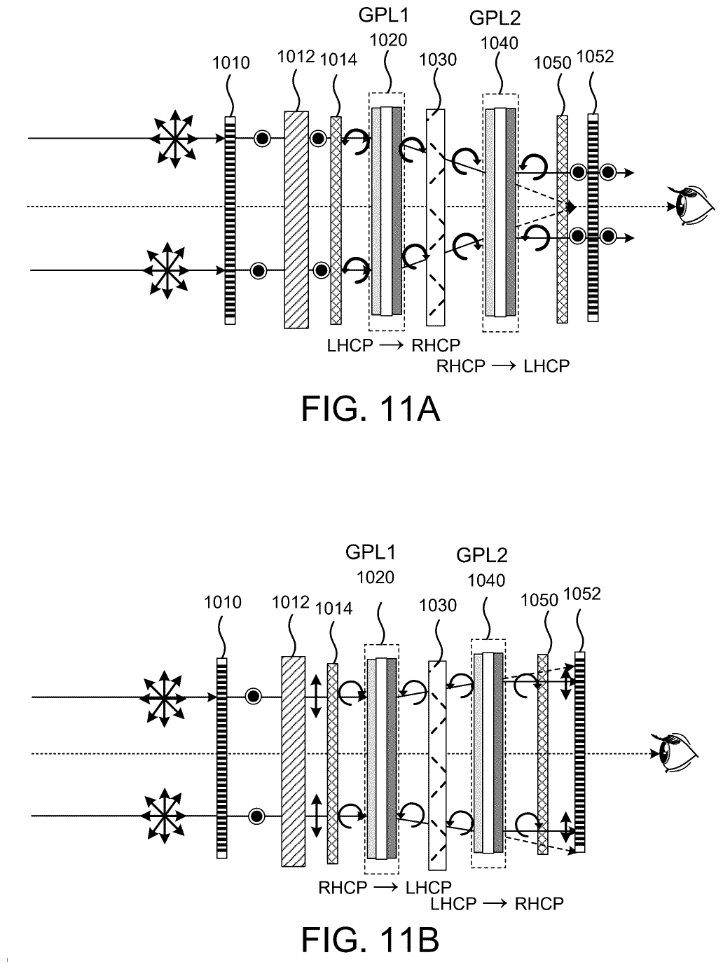

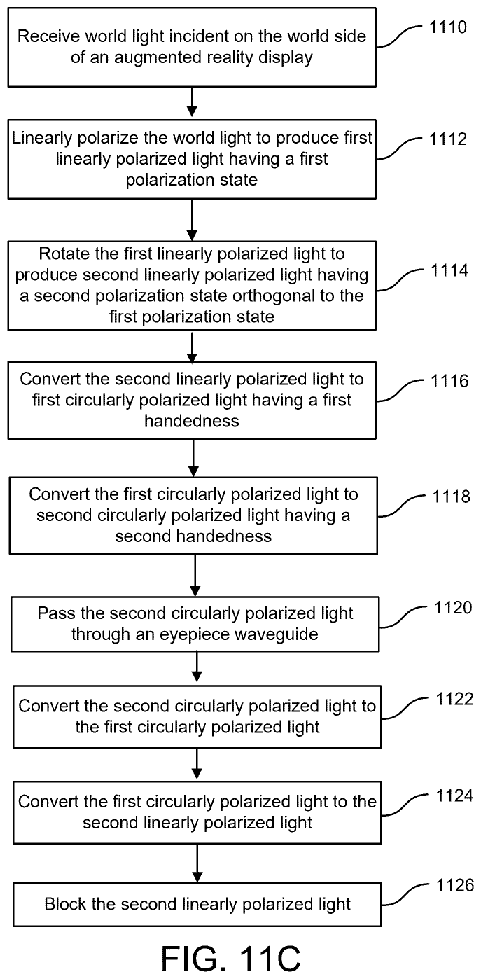

In some embodiments, three powered elements are utilized in the integrated optical stack. For cosmetic reasons, it may be desirable to utilize a curved front lens (i.e., a cosmetic lens) optically upstream of the front GPL/front refractive lens. For certain architectures, curving the front element will introduce additional optical power that is then compensated for in the integrated optical stack. Thus, for example, in an embodiment using a front GPL (GPL1) and a rear GPL (GPL2) as illustrated in FIGS. 11A and 111B, the focal lengths could be f_{cosmetic}+f_{GPL1}+f_{GPL2}=0, where f_{cosmetic} is the focal length of the cosmetic lens, f_{GPL1} is the focal length of the front GPL, and f_{GPL2} is the focal length of the rear GPL. Typically, f_{cosmetic} will be greater than the absolute value of f_{GPL2} and f_{GPL1} will be negative.

FIG. 9C is a simplified schematic diagram illustrating an eyepiece waveguide display including a rear geometric-phase lens according to a particular embodiment of the present invention. The eyepiece waveguide display 940 illustrated in FIG. 9C shares common elements with the eyepiece waveguide display 900 illustrated in FIG. 9A and the description provided in relation to FIG. 9A is applicable to FIG. 9C as appropriate.

As illustrated in FIG. 9C, eyepiece waveguide display 940 includes front lens 910, eyepiece 930, first linear polarizer 912, and first quarter-wave plate 916. Eyepiece waveguide display 940 also includes rear GPL 920. In this embodiment, the transmission axis of first linear polarizer 912 is set at LP1=0° and the optic axis of first quarter-wave plate 916, defined as φ_{c1} is set at φ_{c1}−45°.

FIG. 9D illustrates world light propagation through the eyepiece waveguide display illustrated in FIG. 9C according to an embodiment of the present invention. During operation as illustrated in FIG. 9D, unpolarized world side light is defocused by front lens 910, which is implemented as a refractive lens in this embodiment, and passes through eyepiece 930 and first linear polarizer 912, which produces linearly polarized light (illustrated as the s-polarization state). Upon passing through first quarter-wave plate 916, the linearly polarized light is converted to LHCP light. After propagating through and focusing by rear GPL 920, the output polarization after rear GPL 920 is RHCP light. This RHCP light passes to the user.

FIG. 9E is a simplified schematic diagram illustrating an eyepiece waveguide display including a rear geometric-phase lens according to another particular embodiment of the present invention. The eyepiece waveguide display 950 illustrated in FIG. 9E shares common elements with the eyepiece waveguide display 900 illustrated in FIG. 9A and the eyepiece waveguide display 940 illustrated in FIG. 9C and the description provided in relation to FIGS. 9A and 9C is applicable to FIG. 9E as appropriate.

As illustrated in FIG. 9E, eyepiece waveguide display 950 includes front lens 910, first linear polarizer 912, liquid crystal cell 914, and eyepiece 930. Eyepiece waveguide display 950 also includes second linear polarizer 924, second quarter-wave plate 922, and rear GPL 920. In this embodiment, the optic axis of second quarter-wave plate 922 defined as φ_{c2} is set at φ_{c2}=−45°, while the transmission axis of first linear polarizer 912 and second linear polarizer 924 are set at LP1=LP2=0°.

FIG. 9F illustrates world light propagation through the eyepiece waveguide display illustrated in FIG. 9E with no active dimming according to an embodiment of the present invention.

When liquid crystal cell 914 is in an OFF-state, the unpolarized world side light is defocused by front lens 910, which is implemented as a refractive lens in this embodiment, passes first linear polarizer 912, which produces linearly polarized light (illustrated as the s-polarization state), and liquid crystal cell 914 operating in the OFF-state. After propagating through eyepiece 930, the linearly polarized light is aligned with the transmission axis of second linear polarizer 924 and passes through second linear polarizer 924, is converted to LHCP light by second quarter-wave plate 922, and is focused and converted to RHCP light by rear GPL 920. Thus, the output polarization after rear GPL 920 is RHCP light. No dimming effect is observed with liquid crystal cell 914 in the OFF-state.

FIG. 9G illustrates world light propagation through the eyepiece waveguide display illustrated in FIG. 9E with active dimming according to an embodiment of the present invention.

When liquid crystal cell 914 is in an ON-state, the unpolarized world side light is defocused by front lens 910, which is implemented as a refractive lens in this embodiment, passes first linear polarizer 912, which produces linearly polarized light (illustrated as the s-polarization state), liquid crystal cell 914 operating in the ON-state, which rotates the polarization state of the linearly polarized light by 90° (e.g., from the s-polarization state to the p-polarization state). After polarization rotation, the linearly polarized light in the second polarization state passes through eyepiece 930. Since the linearly polarized light in this second polarization state is oriented 90° with respect to the transmission axis of second linear polarizer 924, second linear polarizer 924 blocks the transmission of the linearly polarized light. As a result, the original world light does not reach the user. Accordingly, dimming is implemented with liquid crystal cell 914 operating in the ON-state. Dynamic dimming can be implemented by varying the voltage applied to liquid crystal cell 914, for example, reducing the voltage to enable 50% of the linearly polarized light to pass through second linear polarizer 924. If we denote m as the horizontal component of the amplitude that is transmitted through eyepiece waveguide display 900, then the portion of the intensity being blocked is I_{b}=1−m², with m≤1. In this manner, the dimming effect for world light can be realized.

FIG. 10 is a simplified schematic diagram illustrating an eyepiece waveguide display including both a front geometric-phase lens and a rear geometric-phase lens according to an embodiment of the present invention. As illustrated in FIG. 10, front GPL 620, also referred to as a world side GPL or GPL1, is utilized to replace a world side refractive lens in the eyepiece waveguide display 1000. Additionally, second GPL 1040, also referred to as a use side GPL or GPL2, is utilized to replace a user side refractive lens in the eyepiece waveguide display 1000. First GPL 1020 (also referred to as a front GPL) and second GPL 1040 (also referred to as a back GPL) can include three CS-GPLs (e.g., first CS-GPL 1023, second CS-GPL 1025, and third CS-GPL 1027; and first CS-GPL 1033, second CS-GPL 1035, and third CS-GPL 1037, respectively) as discussed in relation to front GPL 620 in FIG. 6.

Referring to FIG. 10, the eyepiece waveguide display 1000 includes a number of optical elements disposed along optical axis 1005 extending from the world side to the user side, represented by the user's eye. These optical elements include a first linear polarizer 1010 (LP1), a liquid crystal cell 1012, and a first quarter-wave plate 1014 (QWP1). As described herein, first linear polarizer 1010, liquid crystal cell 1012, and first quarter-wave plate 1014 form an optical dimmer structure. In some embodiments, second quarter-wave plate 1050 and second linear polarizer 1052 can be included as elements of the optical dimmer structure. Thus, in some embodiments, the world side optical structure includes second quarter-wave plate 1050 and second linear polarizer 1052, whereas in other embodiments, these elements can be included as components of the optical dimmer structure. In operation, incident light is linearly polarized by first linear polarizer 1010 and the polarization state of the linearly polarized light can be rotated by liquid crystal cell 1012. Depending on the polarization state (e.g., either the s-polarization state or the p-polarization state) produced using liquid crystal cell 1012, first quarter-wave plate 1014 will produce RHCP or LHCP. Working in conjunction with second quarter-wave plate 1050 and second linear polarizer 1052 described below, world light can be dimmed using the optical dimmer structure.

The optical elements further include first GPL 1020, eyepiece waveguide 1030 (EP), second GPL 1040, a second quarter-wave plate 1050 (QWP2), and a second linear polarizer 1052 (LP2). The focal length of first GPL 1020 and second GPL 1040 are equal and opposite to each other, i.e., first GPL 1020 has a focal length equal to f and second GPL 1040 has a focal length equal to −f. As a result, world light will reach the user without being focused or defocused.

Different variations of eyepiece waveguide display 1000 illustrated in FIG. 10 exist as discussed in relation to eyepiece waveguide display 600 illustrated in FIG. 6. Configurations include: (1) The optic axis of first quarter-wave plate 1014 and second quarter-wave plate 1050 are aligned with the same direction, which has angle of ±45° with respect to the transmission axes of first linear polarizer 1010 and second linear polarizer 1052, while first linear polarizer 1010 and second linear polarizer 1052 have the same transmission direction; (2) The optic axis of first quarter-wave plate 1014 and second quarter-wave plate 1050 are orthogonal to each other, which has angle of ±45° with respect to the transmission axes of first linear polarizer 1010 and second linear polarizer 1052, while first linear polarizer 1010 and second linear polarizer 1052 have orthogonal transmission directions. In both configurations, liquid crystal cell 1012 can adopt two options: (1) a rotator with FW retardation that rotates the polarization state by 90°; (2) HW retardation. In this case, liquid crystal cell 1012 has a linear polarizer with the transmission axis orthogonal to the transmission axis of first linear polarizer 1010. Finally, first GPL 1020 and second GPL 1040 can have similar or opposite phase profiles.

Although in this embodiment, liquid crystal cell 1012 is positioned between first linear polarizer 1010 and first quarter-wave plate 1014, this is not required and these optical elements, as well as other optical elements can be moved to different positions along the optical axis as appropriate to the particular application. Thus, the optical elements illustrated in FIG. 10 can be positioned at other locations as appropriate to the particular application and the order of the positioning of optical elements from world side to user side illustrated in FIG. 10 is not required. One of ordinary skill in the art would recognize many variations, modifications, and alternatives.

FIG. 11A illustrates world light propagation through the eyepiece waveguide display illustrated in FIG. 10 with no active dimming according to an embodiment of the present invention. As described below, in the OFF-state of the liquid crystal cell, no dimmer effect appears.

To illustrate the polarization evolution as light propagates through eyepiece waveguide display 1000 illustrated in FIG. 10, one of the possible arrangements is utilized, an arrangement in which the optic axis of the first quarter-wave plate and the second quarter-wave plate are orthogonal, i.e., the optic axis of first quarter-wave plate 1014, defined as φ_{c1} is set at φ_{c1}=−45° and the optic axis of second quarter-wave plate 1050 φ_{c2} is set at φ_{c2}=45°, while the transmission axis of first linear polarizer 1010 and second linear polarizer 1052 are set at LP1=LP2=0°. In this embodiment, first GPL 1020 is designed to receive LHCP light as input in order to implement 1^{st} order diffraction and focusing (i.e., a positive focal length f) and second GPL 1040 is designed to receive RHCP light as input in order to implement 1^{st} order diffraction and defocusing (i.e., a negative focal length f) as depicted in FIG. 11A.

When liquid crystal cell 1012 is in an OFF-state, the unpolarized world side light passes first linear polarizer 1010, which produces linearly polarized light (illustrated as the s-polarization state), liquid crystal cell 1012 operating in the OFF-state, which does not change the polarization state of the linearly polarized light, and first quarter-wave plate 1014, which produces LHCP light. After focusing by first GPL 1020, the output polarization after first GPL 1020 is RHCP light. This RHCP light passes through eyepiece waveguide 1030 and is incident on second GPL 1040. Second GPL 1040, which has a negative focal length of −f, defocuses the incident light and converts the RHCP light into LHCP light, which, after passing through second quarter-wave plate 1050, is converted to linearly polarized light (illustrated as the s-polarization state). The linearly polarized light is aligned with the transmission axis of second linear polarizer 1052, which enables the linearly polarized light to reach the user. Thus, no dimming effect is observed with liquid crystal cell 1012 is in the OFF-state.

FIG. 11B illustrates world light propagation through the eyepiece waveguide display illustrated in FIG. 10 with active dimming according to an embodiment of the present invention. As described below, in the ON-state of the liquid crystal cell, a dimmer effect appears.

When liquid crystal cell 1012 is in an ON-state, the unpolarized world side light passes first linear polarizer 1010, which produces linearly polarized light (illustrated as the s-polarization state), liquid crystal cell 1012 operating in the ON-state, which rotates the polarization state of the linearly polarized light by 90° (e.g., from the s-polarization state to the p-polarization state), and first quarter-wave plate 1014, which produces RHCP light. After focusing by first GPL 1020, which is characterized by a positive focal length f, the output polarization after first GPL 1020 is LHCP light. This LHCP light passes through the eyepiece waveguide 1030 and is incident on second GPL 1040, which has a negative focal length of −f, defocuses the incident light and converts the LHCP light into RHCP light, which, after passing through second quarter-wave plate 1050, is converted to linearly polarized light (illustrated as the p-polarization state). The linearly polarized light is oriented 90° with respect to the transmission axis of second linear polarizer 1052, which blocks the transmission of the linearly polarized light. As a result, the original world light does not reach the user. Accordingly, dimming is implemented with liquid crystal cell 1012 operating in the ON-state. Dynamic dimming can be implemented by varying the voltage applied to liquid crystal cell 1012, for example, reducing the voltage to enable 50% of the linearly polarized light to pass through second linear polarizer 1052. If we denote m as the horizontal component of the amplitude that is transmitted through eyepiece waveguide display 1000, then the portion of the intensity being blocked is I_{b}=1−m², with m≤1. In this manner, the dimming effect for world light can be realized.

FIG. 11C is a simplified flowchart illustrating a method of performing dynamic dimming for an eyepiece waveguide display according to an embodiment of the present invention. The method can be applied to operating an augmented reality display having a world side and a user side. The method 1100 includes receiving world light incident on the augmented reality display from the world side (1110) and linearly polarizing the world light to produce first linearly polarized light characterized by a first polarization state (e.g., an s-polarization state) (1112). The method also includes rotating the first linearly polarized light to produce second linearly polarized light characterized by a second polarization state (e.g., a p-polarization state) orthogonal to the first polarization state (1114), converting the second linearly polarized light to first circularly polarized light having a first handedness (e.g., RHCP) (1116), and converting the first circularly polarized light to second circularly polarized light having a second handedness (e.g., LHCP) (1118). The method further includes passing the second circularly polarized light through an eyepiece waveguide (1120), converting the second circularly polarized light to the first circularly polarized light (1122), converting the first circularly polarized light to the second linearly polarized light (1124), and blocking the second linearly polarized light (1126).

The method can also include, concurrently with converting the first circularly polarized light to the second circularly polarized light, defocusing the second circularly polarized light. Additionally, concurrently with converting the second circularly polarized light to the first circularly polarized light, the method can include focusing the first circularly polarized light. The method can further include, prior to rotating the first linearly polarized light, converting the first linearly polarized light to the second circularly polarized light, initially converting the second circularly polarized light to the first circularly polarized light, passing the first circularly polarized light through the eyepiece waveguide, initially converting the first circularly polarized light to the second circularly polarized light, converting the second circularly polarized light to the first linearly polarized light, and passing the first linearly polarized light through a linear polarizer. The method can include, concurrently with initially converting the second circularly polarized light to the first circularly polarized light, focusing the first circularly polarized light. Alternatively, concurrently with initially converting the first circularly polarized light to the second circularly polarized light, the method can include defocusing the second circularly polarized light. The method can also include generating virtual content using the eyepiece waveguide, directing the virtual content toward the user side, defocusing the virtual content, and defocusing the second circularly polarized light.

It should be appreciated that the specific steps illustrated in FIG. 11C provide a particular method of performing dynamic dimming for an eyepiece waveguide display according to an embodiment of the present invention. Other sequences of steps may also be performed according to alternative embodiments. For example, alternative embodiments of the present invention may perform the steps outlined above in a different order. Moreover, the individual steps illustrated in FIG. 11C may include multiple sub-steps that may be performed in various sequences as appropriate to the individual step. Furthermore, additional steps may be added or removed depending on the particular applications. One of ordinary skill in the art would recognize many variations, modifications, and alternatives.

FIGS. 12A-C illustrate liquid crystal orientation, wrapped geometric-phase, and total geometric-phase for a geometric-phase lens in a first wavelength band. FIGS. 12D-F illustrate liquid crystal orientation, wrapped geometric-phase, and total geometric-phase for a geometric-phase lens in a second wavelength band. FIGS. 12G-I illustrate liquid crystal orientation, wrapped geometric-phase, and total geometric-phase for a geometric-phase lens in a third wavelength band.

In FIGS. 12A-I, three different lensing functions are illustrated by the use of three columns of plots. As discussed more fully below, chromatic aberrations that can be associated with a GPL are mitigated by color-splitting. The color-split GPLs (CS-GPLs) can be described as three different diffractive lenses, referred to as the three components of the GPL, with the geometric-phase designed for each of the three colors (e.g., blue, green, and red), respectively.

Referring to FIGS. 12A-C, the first column of plots represents a first component of a geometric-phase lens (e.g., a blue lens) including an LCP with an orientation Φ of the slow axis of the LCP varying in an oscillatory manner as a function of radius as shown in FIG. 12A. As illustrated in FIG. 12A, starting at radius r=0, the local orientation of the slow axis increases with radius, reaching 2π, effectively zero degrees, increasing again until it reaches 2π, etc. As the radius increases, the period of the oscillation decreases.

The geometric-phase δ_{g} for the first component of the geometric-phase lens has a wrapped phase profile as shown in FIG. 12B and a total geometric-phase profile as shown in FIG. 12C. The distinctive parabolic shape of the total geometric-phase profile along the radius of the first component as illustrated in FIG. 12C is produced by the orientation Φ of the LCP as a function of radius resulting in the geometric-phase δ_{g}=2Φ. On the other hand, the HW retardation brings the valley of the parabolic phase at the phase of 1π, assuring the geometric-phase lens satisfies the minimum 0^{th} order in Eq. (2). The same discussion applies to a second component (e.g., a green lens) and a third component (e.g., a red lens) illustrated in FIGS. 12D-F and FIGS. 12G-I, respectively. Thus, due to the parabolic phase being wavelength-dependent, the geometric-phase and orientation can be different for each component of the geometric-phase lens. Since the index of refraction is a function of wavelength, the different geometric-phase profiles corresponding to the three different components can result in the focal length of each of the components being the same, mitigating chromatic aberration.

For a specific focal length, the periodicity is determined by both the wavelength and the radius. Therefore, once the focal length for the geometric-phase lens is fixed, the orientation periodicity pattern as a function of the radius can be achieved for the blue, green, and red components as illustrated in FIGS. 12A, 12D, and 12G, respectively. As a result, chromatic aberration is mitigated by each component having a different geometric-phase profile that produces a common focal length for the different wavelength bands. It should be noted that the CS-GPLs discussed herein are not limited to spherical shapes, but can also have an aspheric lens shape, for example, composed by Zernike polynomials.

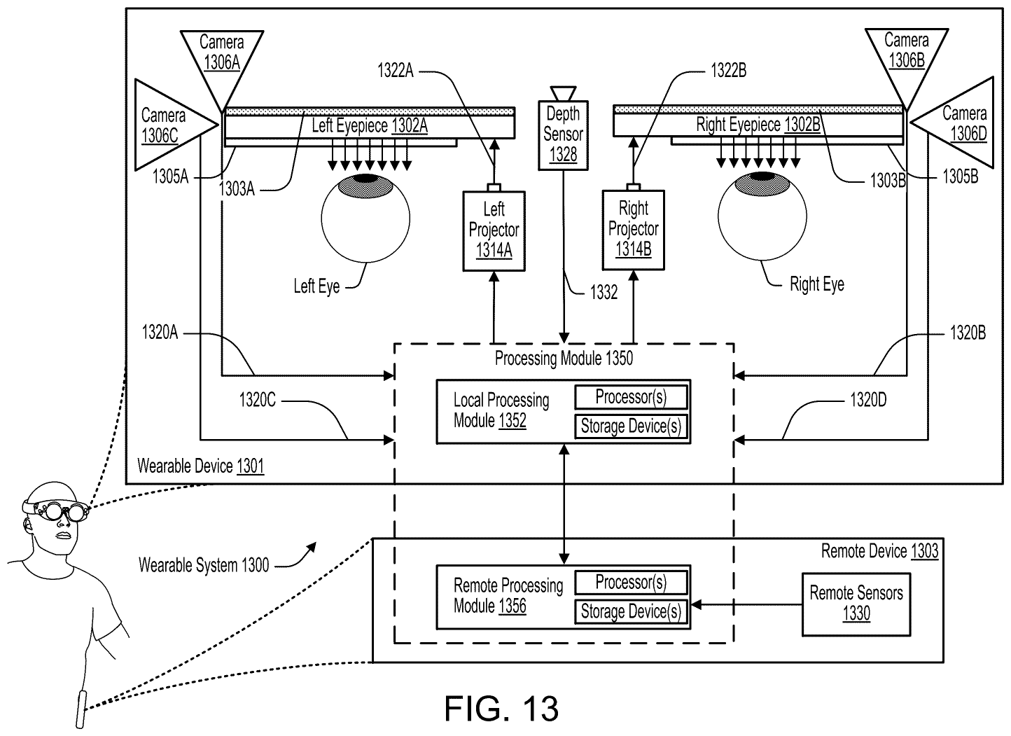

FIG. 13 illustrates a schematic view of an example wearable system 1300 according to an embodiment of the present invention. Wearable system 1300 may include a wearable device 1301 and at least one remote device 1303 that is remote from wearable device 1301 (e.g., separate hardware but communicatively coupled). Wearable system 1300 may alternatively be referred to as an “optical system”, and wearable device 1301 may alternatively be referred to as an “optical device”. While wearable device 1301 is worn by a user (generally as a headset), remote device 1303 may be held by the user (e.g., as a handheld controller) or mounted in a variety of configurations, such as fixedly attached to a frame, fixedly attached to a helmet or hat worn by a user, embedded in headphones, or otherwise removably attached to a user (e.g., in a backpack-style configuration, in a belt-coupling style configuration, etc.).

Wearable device 1301 may include a left eyepiece 1302A, a left lens assembly 1305A, and a left segmented dimmer 1303A arranged in a side-by-side configuration and constituting a left optical stack. Left lens assembly 1305A may include an accommodating lens on the user side of the left optical stack as well as a compensating lens on the world side of the left optical stack. Similarly, wearable device 1301 may include a right eyepiece 1302B, a right lens assembly 1305B, and a right segmented dimmer 1303B arranged in a side-by-side configuration and constituting a right optical stack. Right lens assembly 1305B may include an accommodating lens on the user side of the right optical stack as well as a compensating lens on the world side of the right optical stack.

In some embodiments, wearable device 1301 includes one or more sensors including, but not limited to: a left front-facing world camera 1306A attached to the side of left dimmer 1303A, a right front-facing world camera 1306B attached to the side of right dimmer 1303B, a left side-facing world camera 1306C attached directly to or near left eyepiece 1302A, a right side-facing world camera 1306D attached directly to or near right eyepiece 1302B, and a depth sensor 1328 attached between eyepieces 1302. Wearable device 1301 may include one or more image projection devices such as a left projector 1314A optically linked to left eyepiece 1302A and a right projector 1314B optically linked to right eyepiece 1302B.

Wearable system 1300 may include a processing module 1350 for collecting, processing, and/or controlling data within the system. Components of processing module 1350 may be distributed between wearable device 1301 and remote device 1303. For example, processing module 1350 may include a local processing module 1352 on the wearable portion of wearable system 1300 and a remote processing module 1356 physically separate from and communicatively linked to local processing module 1352. Each of local processing module 1352 and remote processing module 1356 may include one or more processing units (e.g., central processing units (CPUs), graphics processing units (GPUs), etc.) and one or more storage devices, such as non-volatile memory (e.g., flash memory).

Processing module 1350 may collect the data captured by various sensors of wearable system 1300, such as cameras 1306, depth sensor 1328, remote sensors 1330, ambient light sensors, microphones, eye tracking cameras, inertial measurement units (IMUs), accelerometers, compasses, Global Navigation Satellite System (GNSS) units, radio devices, and/or gyroscopes. For example, processing module 1350 may receive image(s) 1320 from cameras 1306. Specifically, processing module 1350 may receive left front image(s) 1320A from left front-facing world camera 1306A, right front image(s) 1320B from right front-facing world camera 1306B, left side image(s) 1320C from left side-facing world camera 1306C, and right side image(s) 1320D from right side-facing world camera 1306D. In some embodiments, image(s) 1320 may include a single image, a pair of images, a video comprising a stream of images, a video comprising a stream of paired images, and the like. Image(s) 1320 may be periodically generated and sent to processing module 1350 while wearable system 1300 is powered on, or may be generated in response to an instruction sent by processing module 1350 to one or more of the cameras.

Cameras 1306 may be configured in various positions and orientations along the outer surface of wearable device 1301 so as to capture images of the user's surrounding. In some instances, cameras 1306A, 1306B may be positioned to capture images that substantially overlap with the FOVs of a user's left and right eyes, respectively. Accordingly, placement of cameras 1306 may be near a user's eyes but not so near as to obscure the user's FOV. Alternatively or additionally, cameras 1306A, 1306B may be positioned so as to align with the incoupling locations of virtual image light 1322A, 1322B, respectively. Cameras 1306C, 1306D may be positioned to capture images to the side of a user, e.g., in a user's peripheral vision or outside the user's peripheral vision. Image(s) 1320C, 1320D captured using cameras 1306C, 1306D need not necessarily overlap with image(s) 1320A, 1320B captured using cameras 1306A, 1306B.

In some embodiments, processing module 1350 may receive ambient light information from an ambient light sensor. The ambient light information may indicate a brightness value or a range of spatially-resolved brightness values. Depth sensor 1328 may capture a depth image 1332 in a front-facing direction of wearable device 1301. Each value of depth image 1332 may correspond to a distance between depth sensor 1328 and the nearest detected object in a particular direction. As another example, processing module 1350 may receive eye tracking data 1334 from eye tracking cameras 1326, which may include images of the left and right eyes. As another example, processing module 1350 may receive projected image brightness values from one or both of projectors 1314. Remote sensors 1330 located within remote device 1303 may include any of the above-described sensors with similar functionality.

Virtual content is delivered to the user of wearable system 1300 using projectors 1314 and eyepieces 1302, along with other components in the optical stacks. For instance, eyepieces 1302A, 1302B may comprise transparent or semi-transparent waveguides configured to direct and outcouple light generated by projectors 1314A, 1314B, respectively. Specifically, processing module 1350 may cause left projector 1314A to output left virtual image light 1322A onto left eyepiece 1302A, and may cause right projector 1314B to output right virtual image light 1322B onto right eyepiece 1302B. In some embodiments, projectors 1314 may include micro-electromechanical system (MEMS) spatial light modulator (SLM) scanning devices. In some embodiments, each of eyepieces 1302A, 1302B may comprise a plurality of waveguides corresponding to different colors. In some embodiments, lens assemblies 1305A, 1305B may be coupled to and/or integrated with eyepieces 1302A, 1302B. For example, lens assemblies 1305A, 1305B may be incorporated into a multi-layer eyepiece and may form one or more layers that make up one of eyepieces 1302A, 1302B.

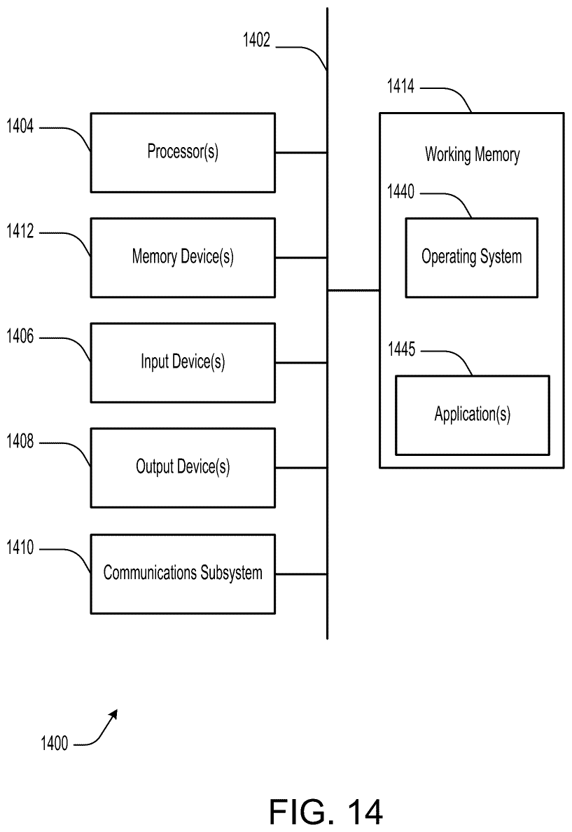

FIG. 14 illustrates an example computer system 1400 comprising various hardware elements according to an embodiment of the present invention. Computer system 1400 may be incorporated into or integrated with devices described herein and/or may be configured to perform some or all of the steps of the methods provided by various embodiments. For example, in various embodiments, computer system 1400 may be incorporated into wearable system 1300 and/or may be configured to perform methods described herein. It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner.

In the illustrated example, computer system 1400 includes a communication medium 1402, one or more processor(s) 1404, one or more input device(s) 1406, one or more output device(s) 1408, a communications subsystem 1410, and one or more memory device(s) 1412. Computer system 1400 may be implemented using various hardware implementations and embedded system technologies. For example, one or more elements of computer system 1400 may be implemented as a field-programmable gate array (FPGA), such as those commercially available by XILINX®, INTEL®, or LATTICE SEMICONDUCTOR®, a system-on-a-chip (SoC), an application-specific integrated circuit (ASIC), an application-specific standard product (ASSP), a microcontroller, and/or a hybrid device, such as an SoC FPGA, among other possibilities.

The various hardware elements of computer system 1400 may be communicatively coupled via communication medium 1402. While communication medium 1402 is illustrated as a single connection for purposes of clarity, it should be understood that communication medium 1402 may include various numbers and types of communication media for transferring data between hardware elements. For example, communication medium 1402 may include one or more wires (e.g., conductive traces, paths, or leads on a printed circuit board (PCB) or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 1402 may include one or more buses connecting pins of the hardware elements of computer system 1400. For example, communication medium 1402 may include a bus that connects processor(s) 1404 with main memory 1414, referred to as a system bus, and a bus that connects main memory 1414 with input device(s) 1406 or output device(s) 1408, referred to as an expansion bus. The system bus may itself consist of several buses, including an address bus, a data bus, and a control bus. The address bus may carry a memory address from processor(s) 1404 to the address bus circuitry associated with main memory 1414 in order for the data bus to access and carry the data contained at the memory address back to processor(s) 1404. The control bus may carry commands from processor(s) 1404 and return status signals from main memory 1414. Each bus may include multiple wires for carrying multiple bits of information and each bus may support serial or parallel transmission of data.

Processor(s) 1404 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 1404 may include one or more multi-core processors, in which each core may read and execute program instructions concurrently with the other cores, increasing speed for programs that support multithreading.

Input device(s) 1406 may include one or more of various user input devices such as a mouse, a keyboard, a microphone, as well as various sensor input devices, such as an image capture device, a pressure sensor (e.g., barometer, tactile sensor), a temperature sensor (e.g., thermometer, thermocouple, thermistor), a movement sensor (e.g., accelerometer, gyroscope, tilt sensor), a light sensor (e.g., photodiode, photodetector, charge-coupled device), and/or the like. Input device(s) 1406 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 1408 may include one or more of various devices that convert information into human-readable form, such as without limitation a display device, a speaker, a printer, a haptic or tactile device, and/or the like. Output device(s) 1408 may also include devices for writing to removable storage devices or other removable media, such as those described in reference to input device(s) 1406. Output device(s) 1408 may also include various actuators for causing physical movement of one or more components. Such actuators may be hydraulic, pneumatic, electric, and may be controlled using control signals generated by computer system 1400.

Communications subsystem 1410 may include hardware components for connecting computer system 1400 to systems or devices that are located external to computer system 1400, such as over a computer network. In various embodiments, communications subsystem 1410 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 1412 may include the various data storage devices of computer system 1400. For example, memory device(s) 1412 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 1404 and memory device(s) 1412 are illustrated as being separate elements, it should be understood that processor(s) 1404 may include varying levels of on-processor memory, such as processor registers and caches that may be utilized by a single processor or shared between multiple processors.

Memory device(s) 1412 may include main memory 1414, which may be directly accessible by processor(s) 1404 via the memory bus of communication medium 1402. For example, processor(s) 1404 may continuously read and execute instructions stored in main memory 1414. As such, various software elements may be loaded into main memory 1414 to be read and executed by processor(s) 1404 as illustrated in FIG. 14. Typically, main memory 1414 is volatile memory, which loses all data when power is turned off and accordingly needs power to preserve stored data. Main memory 1414 may further include a small portion of non-volatile memory containing software (e.g., firmware, such as BIOS) that is used for reading other software stored in memory device(s) 1412 into main memory 1414. In some embodiments, the volatile memory of main memory 1414 is implemented as RAM, such as dynamic random-access memory (DRAM), and the non-volatile memory of main memory 1414 is implemented as read-only memory (ROM), such as flash memory, erasable programmable read-only memory (EPROM), or electrically erasable programmable read-only memory (EEPROM).

Computer system 1400 may include software elements, shown as being currently located within main memory 1414, which may include an operating system 1440, device driver(s), firmware, compilers, and/or other code, such as one or more application programs 1445, which may include computer programs provided by various embodiments of the present disclosure. Merely by way of example, one or more steps described with respect to any methods discussed above, may be implemented as instructions, which are executable by computer system 1400. In one example, such instructions may be received by computer system 1400 using communications subsystem 1410 (e.g., via a wireless or wired signal that carries instructions), carried by communication medium 1402 to memory device(s) 1412, stored within memory device(s) 1412, read into main memory 1414, and executed by processor(s) 1404 to perform one or more steps of the described methods. In another example, instructions may be received by computer system 1400 using input device(s) 1406 (e.g., via a reader for removable media), carried by communication medium 1402 to memory device(s) 1412, stored within memory device(s) 1412, read into main memory 1414, and executed by processor(s) 1404 to perform one or more steps of the described methods.

In some embodiments of the present disclosure, instructions are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 1400. For example, the non-transitory computer-readable medium may be one of memory device(s) 1412 (as shown in FIG. 14). In some cases, the non-transitory computer-readable medium may be separate from computer system 1400. In one example, the non-transitory computer-readable medium may be a removable medium provided to input device(s) 1406 (as shown in FIG. 14), such as those described in reference to input device(s) 1406, with instructions being read into computer system 1400 by input device(s) 1406. In another example, the non-transitory computer-readable medium may be a component of a remote electronic device, such as a mobile phone, that may wirelessly transmit a data signal that carries instructions to computer system 1400 and that is received by communications subsystem 1410 (as shown in FIG. 14).

Instructions may take any suitable form to be read and/or executed by computer system 1400. For example, instructions may be source code (written in a human-readable programming language such as Java, C, C++, C#, Python), object code, assembly language, machine code, microcode, executable code, and/or the like. In one example, instructions are provided to computer system 1400 in the form of source code, and a compiler is used to translate instructions from source code to machine code, which may then be read into main memory 1414 for execution by processor(s) 1404. As another example, instructions are provided to computer system 1400 in the form of an executable file with machine code that may immediately be read into main memory 1414 for execution by processor(s) 1404. In various examples, instructions may be provided to computer system 1400 in encrypted or unencrypted form, compressed or uncompressed form, as an installation package or an initialization for a broader software deployment, among other possibilities.

In one aspect of the present disclosure, a system (e.g., computer system 1400) is provided to perform methods in accordance with various embodiments of the present disclosure. For example, some embodiments may include a system comprising one or more processors (e.g., processor(s) 1404) that are communicatively coupled to a non-transitory computer-readable medium (e.g., memory device(s) 1412 or main memory 1414). The non-transitory computer-readable medium may have instructions (e.g., instructions) stored therein that, when executed by the one or more processors, cause the one or more processors to perform the methods described in the various embodiments.

In another aspect of the present disclosure, a computer-program product that includes instructions (e.g., instructions) is provided to perform methods in accordance with various embodiments of the present disclosure. The computer-program product may be tangibly embodied in a non-transitory computer-readable medium (e.g., memory device(s) 1412 or main memory 1414). The instructions may be configured to cause one or more processors (e.g., processor(s) 1404) to perform the methods described in the various embodiments.

In another aspect of the present disclosure, a non-transitory computer-readable medium (e.g., memory device(s) 1412 or main memory 1414) is provided. The non-transitory computer-readable medium may have instructions (e.g., instructions) stored therein that, when executed by one or more processors (e.g., processor(s) 1404), cause the one or more processors to perform the methods described in the various embodiments.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is an augmented reality display having a world side and a user side, the augmented reality display comprising: a world side optical structure including a geometric-phase lens; an eyepiece waveguide; and a user side optical device.

Example 2 is the augmented reality display of example 1 further comprising an optical dimmer structure.

Example 3 is the augmented reality display of example(s) 2 wherein the optical dimmer structure includes: a linear polarizer; a liquid crystal cell; and a quarter-wave plate.

Example 4 is the augmented reality display of example(s) 3 wherein the linear polarizer is disposed on the world side of the liquid crystal cell and the liquid crystal cell is disposed between the linear polarizer and the quarter-wave plate.

Example 5 is the augmented reality display of example(s) 1-4 wherein the world side optical structure further comprises a quarter-wave plate and a linear polarizer.

Example 6 is the augmented reality display of example(s) 5 wherein the quarter-wave plate and the linear polarizer are disposed between the geometric-phase lens and the eyepiece waveguide.

Example 7 is the augmented reality display of example(s) 1-6 wherein the geometric-phase lens is characterized by a first focal length f and the user side optical device comprises a refractive lens characterized by a second focal length −f.

Example 8 is the augmented reality display of example(s) 1-7 wherein the geometric-phase lens comprises three components, each of the three components being characterized by a geometric-phase profile corresponding to one of three predetermined wavelength bands.

Example 9 is the augmented reality display of example(s) 8 wherein the three predetermined wavelength bands are a blue band, a green band, and a red band.

Example 10 is the augmented reality display of example(s) 1-9 wherein the user side optical device comprises a refractive lens.

Example 11 is a method of operating an augmented reality display having a world side and a user side, the method comprising: receiving world light incident on the augmented reality display from the world side; linearly polarizing the world light to produce first linearly polarized light characterized by a first polarization state; rotating the first linearly polarized light to produce second linearly polarized light characterized by a second polarization state orthogonal to the first polarization state; converting the second linearly polarized light to first circularly polarized light having a first handedness; converting the first circularly polarized light to second circularly polarized light having a second handedness; converting the second circularly polarized light to the second linearly polarized light; and blocking the second linearly polarized light.

Example 12 is the method of example(s) 11 further comprising concurrently with converting the first circularly polarized light to the second circularly polarized light, defocusing the second circularly polarized light.

Example 13 is the method of example(s) 11-12 wherein blocking the second linearly polarized light prevents the second linearly polarized light from reaching an eyepiece waveguide and a rear lens.

Example 14 is the method of example(s) 11-13 wherein the first polarization state comprises an s-polarization state and the second polarization state comprises a p-polarization state.

Example 15 is the method of example(s) 11-14 wherein the first handedness comprises right hand circular polarization and the second handedness comprises left hand circular polarization.

Example 16 is the method of example(s) 11-15 wherein the first handedness is opposite to the second handedness.

Example 17 is the method of example(s) 11-16 wherein, prior to rotating the first linearly polarized light, the method further comprises: converting the first linearly polarized light to the second circularly polarized light; initially converting the second circularly polarized light to the first circularly polarized light; converting the first circularly polarized light to the first linearly polarized light; and passing the first linearly polarized light through an eyepiece waveguide.

Example 18 is the method of example(s) 17 wherein concurrently with initially converting the second circularly polarized light to the first circularly polarized light, focusing the first circularly polarized light.

Example 19 is the method of example(s) 17 further comprising: generating virtual content using the eyepiece waveguide; directing the virtual content toward the user side; defocusing the virtual content; and defocusing the first linearly polarized light.

Example 20 is an augmented reality display having a world side and a user side, the augmented reality display comprising: a world side optical device; an eyepiece waveguide; and a user side optical device, wherein at least one of the world side optical device or the user side optical device includes a geometric-phase lens.

Example 21 is the augmented reality display of example(s) 20 further comprising an optical dimmer structure.

Example 22 is the augmented reality display of example(s) 20-21 wherein the optical dimmer structure includes: a linear polarizer; a liquid crystal cell; and a quarter-wave plate.

Example 23 is the augmented reality display of example(s) 22 wherein the linear polarizer is disposed on the world side of the liquid crystal cell and the liquid crystal cell is disposed between the linear polarizer and the quarter-wave plate.

Example 24 is the augmented reality display of example(s) 20-23 wherein the world side optical device further comprises a quarter-wave plate and a linear polarizer.

Example 25 is the augmented reality display of example(s) 24 wherein the quarter-wave plate and the linear polarizer are disposed between the world side optical device and the eyepiece waveguide.

Example 26 is the augmented reality display of example(s) 20-25 wherein the world side optical device is characterized by a first focal length f and the user side optical device is characterized by a second focal length −f.

Example 27 is the augmented reality display of example(s) 20-26 wherein the geometric-phase lens comprises three components, each of the three components being characterized by a geometric-phase profile corresponding to one of three predetermined wavelength bands.

Example 28 is the augmented reality display of example(s) 27 wherein the three predetermined wavelength bands are a blue band, a green band, and a red band.

Example 29 is the augmented reality display of example(s) 20-28 wherein: the world side optical device comprises the geometric-phase lens; and the user side optical device comprises a refractive lens.

Example 30 is the augmented reality display of example(s) 20-29 wherein: the world side optical device comprises a refractive lens; and the user side optical device comprises the geometric-phase lens.

Example 31 is an augmented reality display, sequentially from a world side to a user side along an optical axis, comprising: a first geometric-phase lens; an eyepiece waveguide; a second geometric-phase lens; and a user side polarization structure.

Example 32 is the augmented reality display of example(s) 31 further comprising an optical dimmer structure.

Example 33 is the augmented reality display of example(s) 32 wherein the optical dimmer structure includes: a first linear polarizer; a liquid crystal cell; and a first quarter-wave plate.

Example 34 is the augmented reality display of example(s) 31-33 wherein the user side polarization structure comprises: a second quarter-wave plate; and a second linear polarizer.

Example 35 is the augmented reality display of example(s) 31-34 wherein the first geometric-phase lens is characterized by a first focal length f and the second geometric phase lens is characterized by a second focal length −f.

Example 36 is the augmented reality display of example(s) 31-25 wherein: the first geometric-phase lens comprises a first set of three components, each component of the first set of three components being characterized by a geometric-phase profile corresponding to one of three predetermined wavelength bands; and the second geometric-phase lens comprises a second set of three components, each component of the second set of three components being characterized by the geometric-phase profile corresponding to one of the three predetermined wavelength bands.

Example 37 is the augmented reality display of example(s) 36 wherein the three predetermined wavelength bands are a blue band, a green band, and a red band.

Example 38 is a method of operating an augmented reality display having a world side and a user side, the method comprising: receiving world light incident on the augmented reality display from the world side; linearly polarizing the world light to produce first linearly polarized light characterized by a first polarization state; rotating the first linearly polarized light to produce second linearly polarized light characterized by a second polarization state orthogonal to the first polarization state; converting the second linearly polarized light to first circularly polarized light having a first handedness; converting the first circularly polarized light to second circularly polarized light having a second handedness; passing the second circularly polarized light through an eyepiece waveguide; converting the second circularly polarized light to the first circularly polarized light; converting the first circularly polarized light to the second linearly polarized light; and blocking the second linearly polarized light.

Example 39 is the method of example(s) 38 wherein concurrently with converting the first circularly polarized light to the second circularly polarized light, defocusing the second circularly polarized light.

Example 40 is the method of example(s) 38-39 wherein concurrently with converting the second circularly polarized light to the first circularly polarized light, focusing the first circularly polarized light.

Example 41 is the method of example(s) 38-39 wherein the first polarization state comprises an s-polarization state and the second polarization state comprises a p-polarization state.

Example 42 is the method of example(s) 38-39 wherein the first handedness comprises right hand circular polarization and the second handedness comprises left hand circular polarization.

Example 43 is the method of example(s) 38-39 wherein the first handedness is opposite to the second handedness.

Example 44 is the method of example(s) 38-39 wherein, prior to rotating the first linearly polarized light, the method further comprises: converting the first linearly polarized light to the second circularly polarized light; initially converting the second circularly polarized light to the first circularly polarized light; passing the first circularly polarized light through the eyepiece waveguide; initially converting the first circularly polarized light to the second circularly polarized light; converting the second circularly polarized light to the first linearly polarized light; and passing the first linearly polarized light through a linear polarizer.

Example 45 is the method of example(s) 44 wherein concurrently with initially converting the second circularly polarized light to the first circularly polarized light, focusing the first circularly polarized light.

Example 46 is the method of example(s) 44-45 wherein concurrently with initially converting the first circularly polarized light to the second circularly polarized light, defocusing the second circularly polarized light.

Example 47 is the method of example(s) 38-46 further comprising: generating virtual content using the eyepiece waveguide; directing the virtual content toward the user side; defocusing the virtual content; and defocusing the second circularly polarized light.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An augmented reality display having a world side and a user side, the augmented reality display comprising:
a world side optical device;
an eyepiece waveguide; and
a user side optical device, wherein at least one of the world side optical device or the user side optical device includes a geometric-phase lens.

2. The augmented reality display of claim 1 further comprising an optical dimmer structure.

3. The augmented reality display of claim 2 wherein the optical dimmer structure includes:
a linear polarizer;
a liquid crystal cell; and
a quarter-wave plate.

4. The augmented reality display of claim 3 wherein the linear polarizer is disposed on the world side of the liquid crystal cell and the liquid crystal cell is disposed between the linear polarizer and the quarter-wave plate.

5. The augmented reality display of claim 1 wherein the world side optical device further comprises a quarter-wave plate and a linear polarizer.

6. The augmented reality display of claim 5 wherein the quarter-wave plate and the linear polarizer are disposed between the world side optical device and the eyepiece waveguide.

7. The augmented reality display of claim 1 wherein the world side optical device is characterized by a first focal length f and the user side optical device is characterized by a second focal length −f.

8. The augmented reality display of claim 1 wherein the geometric-phase lens comprises three components, each of the three components being characterized by a geometric-phase profile corresponding to one of three predetermined wavelength bands.

9. The augmented reality display of claim 8 wherein the three predetermined wavelength bands are a blue band, a green band, and a red band.

10. The augmented reality display of claim 1 wherein:
the world side optical device comprises the geometric-phase lens; and
the user side optical device comprises a refractive lens.

11. The augmented reality display of claim 1 wherein:
the world side optical device comprises a refractive lens; and
the user side optical device comprises the geometric-phase lens.

12. A method of operating an augmented reality display having a world side and a user side, the method comprising:
receiving world light incident on the augmented reality display from the world side;
linearly polarizing the world light to produce first linearly polarized light characterized by a first polarization state;
rotating the first linearly polarized light to produce second linearly polarized light characterized by a second polarization state orthogonal to the first polarization state;
converting the second linearly polarized light to first circularly polarized light having a first handedness;
converting the first circularly polarized light to second circularly polarized light having a second handedness;
converting the second circularly polarized light to the second linearly polarized light; and
blocking the second linearly polarized light.

13. The method of claim 12 further comprising concurrently with converting the first circularly polarized light to the second circularly polarized light, defocusing the second circularly polarized light.

14. The method of claim 12 wherein blocking the second linearly polarized light prevents the second linearly polarized light from reaching an eyepiece waveguide and a rear lens.

15. The method of claim 12 wherein the first polarization state comprises an s-polarization state and the second polarization state comprises a p-polarization state.

16. The method of claim 12 wherein the first handedness comprises right hand circular polarization and the second handedness comprises left hand circular polarization.

17. The method of claim 12 wherein the first handedness is opposite to the second handedness.

18. The method of claim 12 wherein, prior to rotating the first linearly polarized light, the method further comprises:
converting the first linearly polarized light to the second circularly polarized light;
initially converting the second circularly polarized light to the first circularly polarized light;
converting the first circularly polarized light to the first linearly polarized light; and
passing the first linearly polarized light through an eyepiece waveguide.

19. The method of claim 18 wherein concurrently with initially converting the second circularly polarized light to the first circularly polarized light, focusing the first circularly polarized light.

20. The method of claim 18 further comprising:
generating virtual content using the eyepiece waveguide;
directing the virtual content toward the user side;
defocusing the virtual content; and
defocusing the first linearly polarized light.
